(19) United States
(12) Patent Application Publication
(10) Pub. No.: US 2015/0208845 A1
(43) Pub. Date: Jul. 30, 2015

(54) APPARATUS FOR COOKING AND METHODS

(71) Applicant: CircuitLab, Inc., Mountain View, CA (US)

(72) Inventors: Michael Frank Robbins, Mountain View, CA (US); Yuan Wei, Mountain View, CA (US); Kyle William Moss, Mountain View, CA (US); Humberto Evans, Mountain View, CA (US)

(21) Appl. No.: 14/499,752

(22) Filed: Sep. 29, 2014

Related U.S. Application Data
(60) Provisional application No. 61/932,197, filed on Jan. 27, 2014.

(51) Int. Cl. A47J 27/00

(52) U.S. Cl. CPC A47J 27/002

(57) ABSTRACT

One variation of an apparatus for cooking over a burner includes: a vessel including a base defining a channel extending along an external surface of the vessel and over a center of the base, the channel including an undercut; a handle extending outwardly from the vessel; a temperature sensor arranged within the channel proximal the center of the base of the vessel; a closing panel arranged within the channel, constrained by the undercut, and cooperating with the base of the vessel to encapsulate the temperature sensor; an electrical conductor interposed between the base of the vessel and the closing panel, the electrical conductor extending from the temperature sensor to the handle; and a wireless communication module arranged within the handle, coupled to the electrical conductor, and transmitting a unique identifier and a value corresponding to an output of the temperature sensor to an external computing device.

### CROSS REFERENCE TO RELATED APPLICATIONS

This application claims the benefit of U.S. Provisional Application No. 61/932,197, filed on 27 Jan. 2014, which is incorporated in its entirety by this reference.

### TECHNICAL FIELD

This invention relates generally to the field of cooking devices, and more specifically to a new and useful apparatus and methods for cooking in the field of cooking devices.

### BRIEF DESCRIPTION OF THE FIGURES

FIGS. 1A, 1B, and 1C are schematic representations of an apparatus of one embodiment of the invention;

FIG. 2 is a schematic representation of one variations of the apparatus;

FIG. 3 is a schematic representation of one variation of the apparatus;

FIG. 4 is a schematic representation of one variation of the apparatus;

FIG. 5 is a schematic representation of one variation of the apparatus;

FIG. 6 is a flowchart representation of a method of one embodiment of the invention;

FIG. 7 is a flowchart representation of one variation of the method;

FIG. 8 is a flowchart representation of one variation of the method;

FIG. 9 is a graphical representation of one variation of the method;

FIG. 10 is a flowchart representation of one variation of the method;

FIG. 11 is a graphical representation of one variation of the method;

FIG. 12 is a graphical representation of one variation of the method;

FIG. 13 is a flowchart representation of one variation of the method;

FIG. 14 is a graphical representation of one variation of the method;

FIG. 15 is a graphical representation of one variation of the method; and

FIG. 16 is a graphical representation of one variation of the method.

### DESCRIPTION OF THE EMBODIMENTS

The following description of the embodiment of the invention is not intended to limit the invention to these embodiments, but rather to enable any person skilled in the art to make and use this invention.

### 1. Apparatus

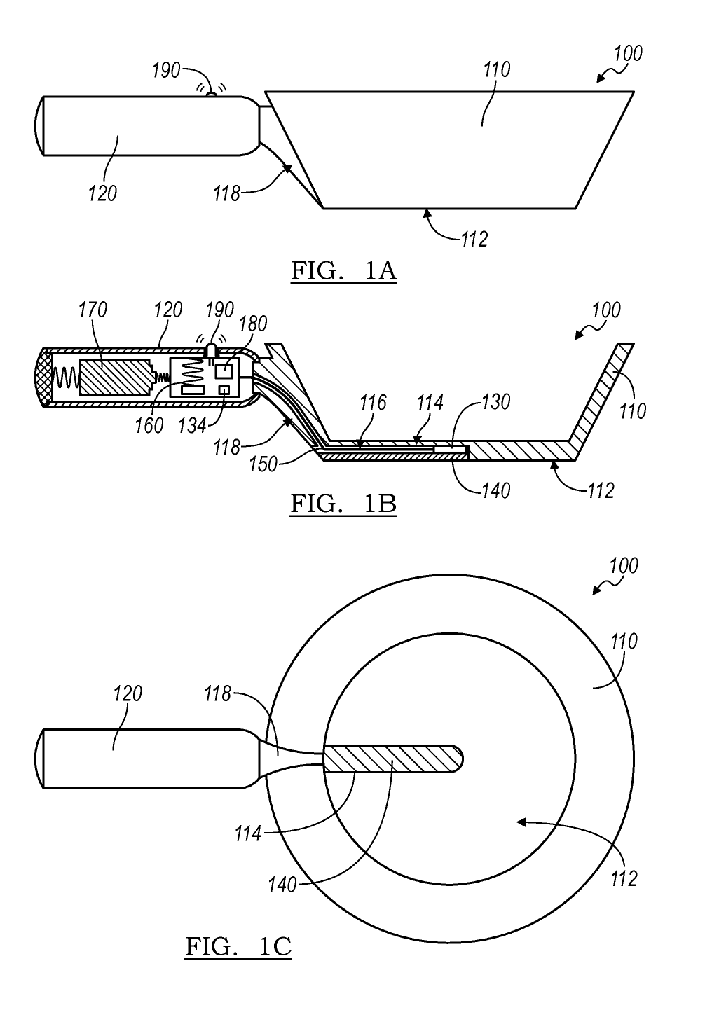

As shown in FIGS. 1A, 1B, and 1C, an apparatus 100 for cooking over a burner includes: a vessel 110 including a base 112 defining a channel 114 extending along an external surface of the vessel 110 and over a center of the base 112, the channel 114 including an undercut; a handle 120 extending outwardly from the vessel 110; a temperature sensor 130 arranged within the channel 114 proximal the center of the base 112 of the vessel 110; a closing panel 140 arranged within the channel 114, constrained by the undercut, and cooperating with the base 112 of the vessel 110 to encapsulate the temperature sensor 130; an electrical conductor interposed between the base 112 of the vessel 110 and the closing panel 140, the electrical conductor extending from the temperature sensor 130 to the handle 120; and a wireless communication module 160 arranged within the handle 120, coupled to the electrical conductor 150, and transmitting a unique identifier and a value corresponding to an output of the temperature sensor 130 to an external computing device.

One variation of the apparatus 100 includes: a vessel including a base defining a channel extending along an external surface of the vessel 110 and over a central axis of the base 112, the channel 114 including an undercut; a handle extending outwardly from the vessel 110; a temperature sensor 130 arranged within the channel 114 and coincident the central axis of the base 112 of the vessel 110; a closing panel arranged within the channel 114, constrained by the undercut, and cooperating with the base 112 of the vessel 110 to encapsulate the temperature sensor 130; an electrical conductor 150 interposed between the base 112 of the vessel 110 and the closing panel 140, the electrical conductor 150 extending from the temperature sensor 130 to the handle 120; a thermal isolator interposed between the temperature sensor 130 and the closing panel 140; a battery 170 arranged within the handle 120; and a wireless communication module 160 arranged within the handle 120, powered by the battery 170, and operable between a first mode and a second mode, the wireless communication module 160 broadcasting a unique identifier at a first rate in the first mode, transitioning from the first mode into the second mode in response to wireless communication with an external computing device, and transmitting a first value corresponding to a substantially current output of the temperature sensor 130 and a second value corresponding to a voltage of the battery 170 at a second rate to the external computing device in the second mode.

### 1.1 Applications

The apparatus 100 functions as a vessel for cooking foodstuffs, the vessel 110 conducting heat from an external energy source into one or more foodstuffs contained therein. The apparatus 100 further incorporates a temperature sensor 130 and a wireless communication module 160 (e.g., a wireless transmitter or transceiver) that broadcasts temperature measurements from the temperature sensor 130 to an external computing device (e.g., a smartphone, a tablet). In particular, the apparatus 100 can interface wirelessly with an external computing device to communicate real temperatures of the cooking vessel to the computing device substantially in real-time. As described below, the external computing device can execute a native cooking guide application or other software program to receive a recipe selection from a user, to provide recipe preparation instructions to the user, to prompt the user to make cooking temperature adjustments according to the recipe, to track heat exposure of the contents of the cooking vessel over time, and to indicate when the dish is complete based on the heat exposure of the contents of the cooking vessel and the recipe. Therefore, the apparatus 100 can collect temperature data during a cooking period, a software program executing on a remote computing device can generate prompts for adjusting cooking variables based on a selected recipe and temperature data received from the apparatus 100 (as described below), and a user can provide actuation to execute the prompts generated by the software program.

The apparatus 100 can therefore cooperate with an external computing device executing one or more variations of the method described below to guide a user in achieving and maintaining proper heat conditions within the cooking vessel while cooking a dish. For example, a novice cook can exercise the apparatus 100 and the method at home to properly cook selected dishes and to learn proper cooking temperatures for various foods. In another example, an experienced cook can exercise the apparatus 100 and the method to cook the same dish repeatedly across various different stovetops, such as when visiting various friends or family members. In yet another example, a professional chef can exercise the apparatus 100 and the method to learn temperature controls for a new stovetop or to manage multiple similar apparatus woes to cook various dishes simultaneously in a professional kitchen.

The apparatus 100 is configured for placement on a stovetop burner, such as a gas, resistive, or inductive stovetop burner with manually-operated heat (temperature) control. Generally, the apparatus 100 is described herein in the form of a frying pan (or “frypan,”, “skillet”), wherein the cooking vessel defines a frustoconical section with substantially flat bottom and flared sidewall, and wherein the handle 120 extends outwardly from the flared sidewall of the cooking vessel. However, the apparatus 100 can alternatively take the form of a sauté pan, saucepan, wok, Dutch oven, roaster, grill pan, griddle, or other suitable cooking vessel configured for heating on a stovetop burner.

### 1.2 Cooking Vessel

The vessel 110 includes a base defining a channel extending along an external surface of the vessel 110 and over a center (e.g., a central axis) of the base 112, the channel 114 including an undercut. Generally, the vessel 110 functions as a primary container configured to accommodate one or more ingredients and to communicate heat from a burner (e.g., a gas burner, an electric resistive burner, an inductive ‘burner’) into the one or more ingredients during a cooking cycle. The vessel 110 can therefore be of or include a thermally-conductive material, such as cast or spun aluminum, cast iron, stainless steel, or copper. In one example, the vessel 110 includes a primary, non-ferrous base materials, such as aluminum, and a secondary ferrous material, such as an iron or steel plate, embedded within the non-ferrous base material such that the apparatus 100 is compatible with electric induction stovetops. The vessel 110 can also be coated with a “non-stick” or protective material, such as Teflon or enamel.

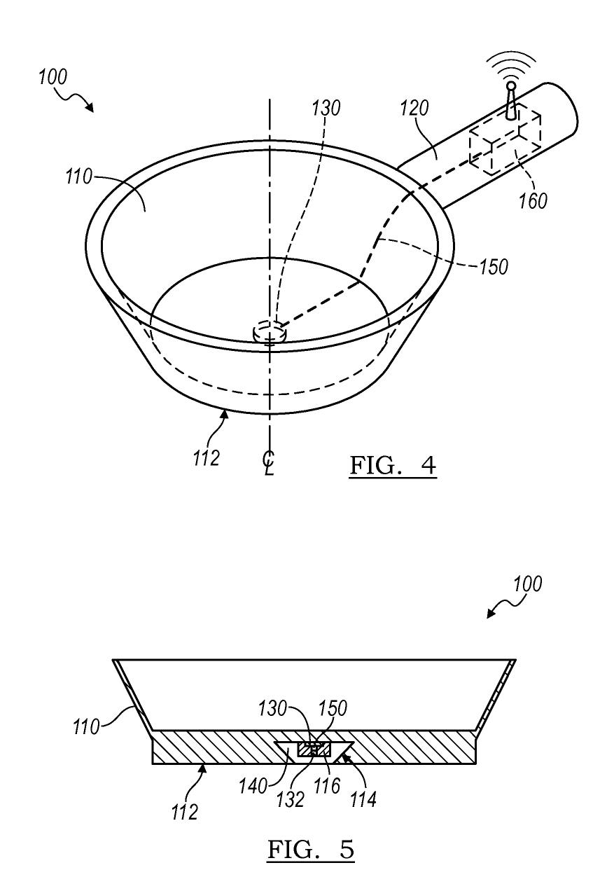

The vessel 110 further functions to define a channel that receives the temperature sensor 130, the electrical conductor 150, and the closing panel 140. In one implementation, the vessel 110 includes a frustoconical container defining a substantially flat bottom and a conical (i.e., round, flared) sidewall, as described above. In this implementation, the vessel 110 therefore also defines a central axis, and the vessel 110 defines the channel 114 on the outside (i.e., external surface) of the base of the frustoconical container and extending over the central axis of the frustoconical container, as shown in FIG. 4. As described below, the temperature sensor 130 can thus be arranged within the channel 114 in the base 112 of the vessel 110 proximal (e.g., substantially concentric with) the central axis of the frustoconical container. The vessel no can alternatively include a container of cylindrical, ovular, rectilinear, or other section, and the vessel 110 can define the channel 114 along the outside of the base 112 of the vessel 110 and extending through an effective center (e.g., central axis) of the container. Yet alternatively, the vessel 110 can define the channel 114 that extends over any other portion of the container.

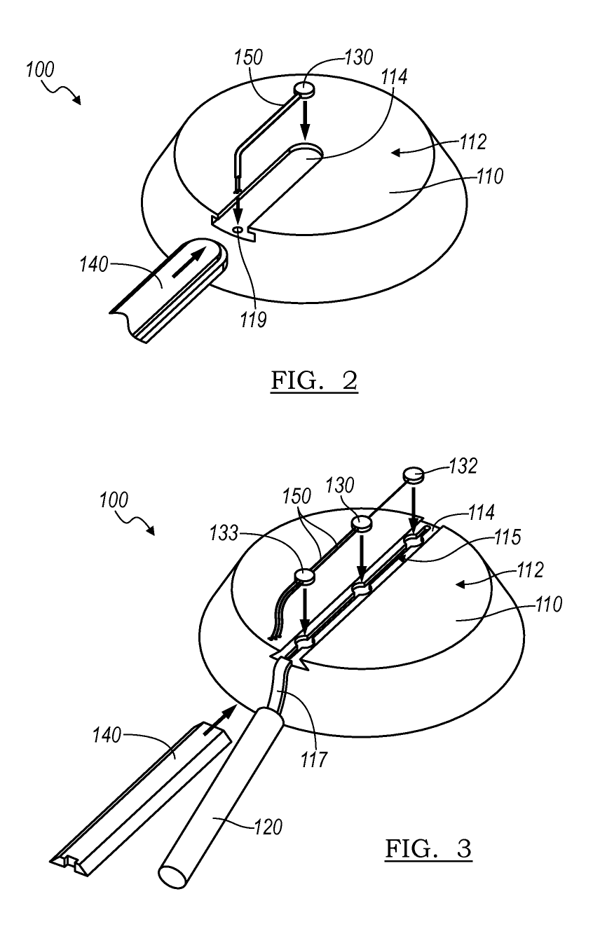

The vessel 110 can define the channel 114 that includes an undercut section. For example, the channel 114 can define a dovetail cross-section (shown in FIGS. 3 and 5) or a T-slot cross-section (shown in FIG. 2) extending linearly across the outside of the base 112 of the container, and the closing panel 140 can be of an linear mating geometry configured to slide into and to be retained by the channel 114, the closing panel 140 thus cooperating with the vessel 110 to enclose the temperature sensor 130 and the electrical conductor 150 within the channel 114. The undercut geometry of the channel 114 can thus capture and retain the closing panel 140, the vessel no and the closing panel 140 thus cooperating to enclose the temperature sensor 130 and the electrical conductor 150. In particular, the closing panel 140 can be installed into the channel 114 by inserting a leading end of the closing panel 140 into the channel 114 and sliding the closing panel 140 linearly into the channel 114 until the leading end of the closing panel 140 bottoms against an opposing end of the channel 114. The channel 114 can extend fully across the base 112 of the vessel 110. Alternatively, a first end of the channel 114 can commence at the perimeter of the base 112 of the vessel 110, and a second end of the channel 114 can terminate inside the perimeter of the base 112 of the vessel 110 such that the closing panel 140 can be installed into the first end of the channel 114 and slid into the channel 114 until a leading edge of the closing panel 140 bottoms on the second end of the channel 114. For example, the second end of the channel 114 can define a square or semi-circular section, and the closing panel 140 can define a mirrored geometry at its leading end to mate with second end of the channel 114 with substantially minimal offset, as shown in FIG. 1C.

The vessel 110 can also define a secondary recess 115 extending along the channel 114, and the temperature sensor 130 and the electrical conductor 150 can be arranged within the secondary recess 115 below the closing panel 140 when the closing panel 140 in installed in the channel 114, as shown in FIG. 3. For example, the secondary recess 115 can be of a depth in the base 112 of the vessel 110—below the channel 114—approximating a thickness of the temperature sensor 130 and/or the electrical conductor 150. Similarly, the secondary recess 115 can be of a depth in the base 112 of the vessel 110—below the channel 114—greater than a thickness of the temperature sensor 130 and/or the electrical conductor 150, and a thermally-conductive material (e.g., a thermal paste of a coefficient of thermal expansion approximately equivalent to a coefficient of thermal expansion of the vessel 110) can be installed (e.g., deposited) around the temperature sensor 130 before the closing panel 140 is installed. Alternatively, as described below, a thermally-insulating material can be arranged between the temperature sensor 130 and the closing panel 140 to substantially isolate the temperature sensor 130 from rapid temperature changes responsive to changes in heating conditions across the base 112 of the vessel 110.

However, the channel 114 can be of any other cross-section, and the closing panel 140 can similarly define any other cross-section suitable for installation into the channel 114. For example, the channel 114 can define a square or rectangular cross section, and the closing panel 140 can define a similarly square or rectangular cross-section placed into the channel 114 and welded to the vessel 110 or pressed into the channel 114 and retained according to an interference fit. The channel 114 can also be curvilinear along its length, such as one quarter of a circular sweep, or any of other suitable geometry along its length.

The channel 114 can be cast or molded directly into the container, or the channel 114 can be machined, etched, stamped, or otherwise formed into the container via a secondary manufacturing process.

The vessel 110 can also define a set of channels, and the apparatus 100 can include a closing panel, a temperature sensor 130, and an electrical conductor 150 installed into each of the set of channels. However, the vessel 110 can be of any other form and can define any number of channel of any suitable geometry and cross-section across any suitable portion of the container.

The handle 120 of the apparatus 100 extends outwardly from the vessel no. Generally, the handle 120 functions as an extension for manipulating the vessel 110 and defines a cavity housing various components of the apparatus 100, such at the wireless communication module 160, a processor 180, and/or a battery, etc. The handle 120 can also extend outwardly from the vessel 110 along a plane substantially parallel to a long axis of the channel 114 such that one end of the channel 114 terminates substantially proximal or adjacent the base of the handle 120. Thus, the electrical conductor 150 can pass directly from the channel 114 into the handle 120 to communicate a signal from the temperature sensor 130 to a component or circuit contained within the handle 120.

In one implementation, the handle 120 and the vessel 110 are physically coextensive. For example, the handle 120 and the vessel 110 can be cast (e.g., in stainless steel, in iron, in aluminum) as a single unit. In this example, the handle 120 can be cast with a cavity in place, or the cavity can be machined into the handle 120 during a secondary manufacturing operation. The channel 114 and a conduit (e.g., a bore)—extending from the channel 114 into the cavity and configured to house a portion of the electrical conductor 150—can similarly be cast into the vessel 110 and the handle 120 or machined into the handle-vessel unit during a secondary machining operation. In an alternative implementation, the handle 120 defines a discrete component fastened to the vessel 110. For example, the handle 120 can be affixed to the vessel 110 by a threaded fastener, a clamp, a rivet, a weld, or an adhesive, etc.

The handle 120 can be of a thermally-insulating material and/or of a material exhibiting relatively low thermal conductively to limit heat conduction into a user's hand during use of the apparatus 100, such as to enable the user to manipulate the apparatus 100 directly via the handle 120 even the vessel 110 is at elevated (cooking) temperatures. Alternatively, the handle 120 can be coated or encased in a thermally-insulating material or in a material exhibiting relatively low thermal conductively. For example, the handle 120 can include a silicone sleeve arranged over an internal steel structure mechanically fastened to the vessel 110.

A distal end of the handle 120 opposite the vessel 110 can further define an opening to the internal cavity, and a cover can be fastened over the opening to enclose one or more components of the apparatus 100 within the handle 120, as shown in FIG. 1B. For example, the cover can be removable from the distal end of the handle 120 to enable replacement of one or more batteries within the handle 120, and the cover can be reinstalled (e.g., by reinstalling one or more screws or other fasteners) to seal various components of the apparatus 100 within the handle 120, such as up to an Liquid Ingress Protection Rating of Level 5 or higher to shield the contents of the handle 120 from dust and moisture when the apparatus 100 is washed inside a dishwasher. In this example, an oring (e.g., a silicone o-ring) can be arranged between the cover and the handle 120 to provide a substantially watertight seal between the cover and the handle 120 once assembled.

The handle 120 can further include a visually and/or tactilely discernible length rule including hashes and length markings. For example, a metric and/or Imperial length rule can be printed in ink, embossed, and/or debossed across a surface of the handle 120. In this example, the length rule can provide guidance to a user in estimating a thickness of an ingredient to be cooked in the apparatus 100, such as a thickness of a steak or a width of an asparagus sprig, which the user can enter into a user interface on an external computing device (e.g., a smartphone, a tablet) and which the method—executing on the external computing device—can apply to a recipe model to calculate a cooking time and a cooking temperature for the ingredient, as described below.

### 1.3 Temperature Sensor

The temperature sensor 130 is arranged within the channel 114 proximal the center (e.g., the central axis) of the base 112 of the vessel 110. Generally, the temperature sensor 130 is arranged within the channel in the vessel 110, is retained between the vessel 110 and closing panel, and outputs (when sampled) a signal corresponding to a temperature of the vessel 110, such as corresponding to a temperature of the vessel 110 proximal an interior surface of the vessel 110 (e.g., “pan”) adjacent its axial center.

The temperature sensor 130 can include any one or more of a thermocouple, a resistance thermometer, a silicon bandgap temperature sensor 130, a silicon diode junction, an integrated circuit temperature sensor 130, and/or any other suitable type of temperature sensor 130. For example, the temperature sensor 130 can include a platinum resistance thermometer (e.g., a Pt100 resistance temperature detector (RTD)), such as in the form of a thin-film platinum wire segment on a ceramic and glass substrate. The temperature sensor 130 can be arranged within the channel 114 or within a secondary recess 115 within the channel 114 on a bottom (i.e., burner-facing) side of the vessel 110. The temperature sensor 130 can be affixed to the vessel 110, such as with an adhesive (e.g., epoxy), a potting material, or a thermal paste to maintain thermal contact with the vessel 110. Alternatively, the temperature sensor 130 can be retained against the vessel 110 (i.e., against an interior face of the channel 114 or the secondary recess 115 on a bottom of the vessel 110) directly by the closing panel 140. Furthermore, the temperature sensor 130 can be electrically coupled directly to the wireless communication module 160, to an analog-to-digital converter, or to a processor, etc. within the handle 120 via the electrical conductor 150, the electrical conductor 150 extending from the temperature sensor 130, along the channel 114 between the vessel 110 and the closing panel 140, and into the handle 120.

In one implementation, as described above, the temperature sensor 130 can be coincident a central axis of the vessel 110 that includes a frustoconical container. In this implementation, due to arrangement of the temperature sensor 130 coincident the central axis of the vessel 110, the temperature sensor 130 can yield, in its output, substantially rapid response to changes in the temperature of the interior surface of the vessel 110 (i.e., an interior surface of the vessel 110 adjacent various ingredients currently cooking in the apparatus 100). Furthermore, the temperature sensor 130 can yield substantially consistent outputs across a cooking temperature range substantially regardless of stovetop type (i.e., gas, electric resistance, or electric induction), non-uniform heating pattern of the adjacent burner, or the apparatus 100 that is askew over the adjacent burner due to arrangement of the temperature sensor 130 proximal the central axis of the vessel 110.

The apparatus 100 can also include multiple temperature sensors. For example, the (first) temperature sensor 130 can be arranged within the channel 114 coincident the central axis of the vessel 110, a second temperature sensor 132 and a third temperature sensor 133 can be arranged within the channel 114 equidistant from, on each side of, and at a first distance from the first temperature sensor 130, as shown in FIG. 3. In this example, a fourth temperature sensor and a fifth temperature sensor can also be arranged within the channel 114 equidistant from, on each side of, and at a second distance greater than the first distance from the first temperature sensor 130. The closing panel 140 can thus cooperate with the vessel 110 to retain the first, second, third, fourth, and fifth temperature sensors in their respective positions within the channel 114. In this variation, the discrete outputs from each temperature sensor 130 in the set of temperature sensors arranged within the apparatus 100 can be manipulated locally on the apparatus 100 (e.g., by the processor 180) to map a temperature gradient across the vessel 110, to calculate an average temperature of the vessel 110, and/or to detect failure of one or more temperature sensors within the set (e.g., based on a drastic difference between the output of a particular temperature sensor 130 and outputs of the remaining temperature sensors in the set). In particular, the apparatus 100 can include multiple temperature sensors to provide sensor redundancy and/or to enable collection of additional temperature data supporting higher order tracking of heat exposure of an ingredient cooking within the vessel 110. For example, the method—implemented within a native cooking guide application executing on the external computing device—can detect uneven heating or uneven distribution of contents in the vessel 110 based on variances across outputs of multiple temperature sensors within the apparatus 100, and the method can generate and deliver to a user a prompt to stir contents of the vessel 110 accordingly.

In a similar variation, the apparatus 100 can include a second temperature sensor 132 stacked vertically over the (first) temperature sensor 130 within the channel 114 (or within a secondary recess 115 within the channel 114), as shown in FIG. 5. For example, the method—implemented within a native cooking guide application—can calculate a heat flux through the base 112 of the vessel 110 (i.e., from the burner to the interior surface of the vessel 110 adjacent one or more ingredients contained therein) based on a difference between an output of the first temperature sensor 130 and an output of the second temperature sensor 132 at a particular time. In this example, the method can correlate a temperature drop at the first temperature sensor 130 adjacent the bottom of the vessel 110 preceding a corresponding temperature drop at the second temperature sensor 132 adjacent the interior surface of the pan with removal of the apparatus 100 from a burner or a reduction in thermal output of the burner, and the method can correlate a temperature drop at the second temperature sensor 132 preceding a corresponding temperature drop at the first temperature sensor 130 with additional of a cold (e.g., frozen) ingredient into the vessel 110.

However, the temperature sensor 130 can be any other suitable type of sensor and connected to one or more integrated circuits within the handle 120 in any other suitable way, and the apparatus 100 can include any other number of temperature sensors arranged in any other suitable way.

The electrical conductor 150 is interposed between the base 112 of the vessel 110 and the closing panel 140 and extends from the temperature sensor 130 to the handle 120. Generally, the electrical conductor 150 functions to carry an electrical signal from the temperature sensor 130 to the wireless communication module 160, to an analog-to-digital converter, or to a processor, and/or to any other component or circuit within the handle 120. In one implementation, the electrical conductor 150 includes two leads, each of which is welded to a lead of the temperature sensor 130. For example, each lead of the electrical conductor 150 can be welded to a corresponding lead of the temperature sensor 130 via a capacitive discharge welding process to yield a connection between the electrical conductor 150 and the temperature sensor 130 that is suitably stable at elevated temperatures common to stovetops (and to frying pans, etc.). Each lead of the electrical conductor 150 can be electrically isolated—such as from the other lead of the electrical conductor 150, from the vessel 110, and/or from the closing panel 140, etc.—by a multilayer wound fiberglass sleeve or “jacket” encasing (i.e., wrapped around) the lead. Alternatively, a lead of the electrical conductor 150 can be insulated with a silicone sleeve, a (high-temperature) potting material, or any other suitable material of any other suitable form.

In one implementation, the vessel 110 defines a keel 118 extending from the base 112 of the container to the handle 120, the keel 118 thus yielding a substantially continuous transition from the base 112 of the container to the handle 120. In this implementation, the keel 118 can feature an internal bore 119, and the channel 114 can terminate at the keel 118 and over the internal bore 119. Thus, the electrical conductor 150 can be installed within the channel 114 and pass directly through the internal bore 119 into the handle 120, and the closing panel 140 can be installed in the channel 114 to enclose both the electrical conductor 150 and the internal bore 119, as shown in FIG. 2.

In another implementation, the apparatus 100 includes a tube 117 extending from the channel 114 to the handle 120, and the electrical conductor 150 passes through the tube 117 from one end of the channel 114 into the handle 120. In this implementation, the tube 117 can follow a contour of (a sidewall of) the vessel 110 from the base 112 of the container toward the handle 120 and can be of aluminum, silicone, steel, copper, fiberglass, or any other suitable material that is stable under common stovetop heating conditions. The tube 117 can thus protect the electrical conductor 150 and any insulator jacketed around the electrical conductor 150 from exposure to water, solvents, detergents, direct or indirect heat (e.g., an open flame), and/or mechanical impact, etc. during use, cleaning, or storage. Furthermore, a junction between the tube 117 and the channel 114 and/or a junction between the tube 117 and the handle 120 can be sealed, such as with a silicone adhesive or a silicone o-ring compressed between the tube 117 and an adjacent component of the apparatus 100 during assembly.

However, the electrical conductor 150 can pass through any other one or more components of the apparatus 100 before entering an interior cavity of the handle 120.

### 1.4 Closing Panel

The closing panel 140 is arranged within the channel 114, is constrained by the undercut of the channel 114, and cooperates with the base 112 of the vessel 110 to encapsulate the temperature sensor 130. Generally, the closing panel 140 is captured by the channel 114 and functions to enclose the temperature sensor 130 and the electrical conductor 150.

In one implementation in which the channel 114 defines a T-slot, the closing panel 140 can feature a T-shaped cross-section sized to engage the T-slot channel such that the undercut of the channel 114 retains the closing panel 140 in at least two degrees of translation and three degrees of rotation. In another implementation in which the channel 114 defines a dovetail section, the closing panel 140 can feature a dovetailed cross-section sized to engage the dovetailed channel. However, the channel 114 can be of any other suitable cross-section, and the closing panel 140 can be sized to mate with the channel 114 accordingly.

The closing panel 140 can also be sized for an interference fit with the channel 114. For example, the channel 114 can be a T-slot exhibiting a nominal width dimension at a base of the T′ of 0.2500″, and the corresponding base of the ‘T’ of the closing panel 140 can exhibit a nominal width dimension of 0.2501″ for a 0.0001″ interference fit. In this implementation, the closing panel 140 can be mechanically pressed into the channel 114. Alternatively, the closing panel 140 can be shrink fit into the channel 114 by heating the vessel 110 and/or cooling the closing panel 140 and the inserting the (cooled) closing panel into the channel 114 of the (heated) vessel. Alternatively, the closing panel 140 can be undersized for the channel 114, such as for a running fit between the closing panel 140 and the channel 114, and the closing panel 140 can be welded, brazed, or bonded to the vessel 110, or a portion of the channel 114 and/or the closing panel 140 can be deformed (e.g., with a punch) to retain the closing panel 140 in position within the channel 114.

Therefore, as in the foregoing implementations in which the closing panel 140 is sized, oversized, or undersized for the channel 114, the closing panel 140 can be welded to the base 112 of the vessel 110. For example, the closing panel 140 can be welded to the vessel 110 around the full perimeter of the closing panel 140 (i.e., along each long and short edge of the closing panel 140) via a gas or arc welding technique. Alternatively, the closing panel 140 can be fixed to the vessel 110 via intermittent welds (e.g., spot welds), such as spaced at one-inch intervals along the perimeter of the closing panel 140. Similarly, the closing panel 140 can be retained in the panel by one or more rivets. For example, following assembly of the closing panel 140 into the channel 114, a series of countersunk bores can be drilled or otherwise formed intermittently along the perimeter of the closing panel 140, a rivet then installed in each bore, and each rivet pressed and deformed into its corresponding bore before the exterior surface of the base 112 of the vessel 110 is milled, sanded, or turned flat. In this example, each rivet can also be welded to the closing panel 140 or to the vessel 110 such as via a capacitive-discharge stud welding method. Yet alternatively, the closing panel 140 can be brazed to base of the vessel 110, such as by a dip brazing the closing panel-vessel assembly for the vessel no and the closing panel 140 that include an aluminum alloy(s) or by brass brazing the closing panel-vessel assembly for the vessel 110 and the closing panel 140 that include a steel alloy(s) or cast iron. Alternatively, divots can be punched along the junction between the closing panel 140 and the channel 114, such as spaced evenly and intermittently along the long edges of the closing panel 140 to mechanical lock the closing panel 140 within the channel 114. A high-temperature adhesive can additionally or alternatively be arranged between the channel 114 and the closing panel 140 to retain the closing panel 140 within the channel 114. A mechanical fastener (e.g., a machine screw) can be installed through a through-bore in the closing panel 140 and engage a threaded bore in the vessel 110 (e.g., in the keel 118) to mechanically fasten the closing panel 140 to the vessel 110.

The closing panel 140 can exhibit a coefficient of thermal expansion substantially similar to that of the vessel 110 (or at least the base 112 of the vessel 110) such that the fit between the closing panel 140 and the channel 114 remains substantially unchanged throughout the operating temperature range of the apparatus 100. Alternatively, the closing panel 140 can exhibit a coefficient of thermal expansion greater than that of the vessel 110 such that the fit between the closing panel 140 and the channel 114 tightens as the vessel 110 is heated. Yet alternatively, the closing panel 140 can exhibit a coefficient of thermal expansion less than that of the vessel 110 such that the fit between the closing panel 140 and the channel 114 loosens as the vessel 110 is heated to reduce mechanical stress on the temperature sensor 130 and/or the electrical conductor 150 as the vessel 110 is heated.

The closing panel 140 can be of the same or substantially similar material as the vessel 110, such as aluminum for an aluminum vessel or forged steel for a cast iron vessel. The closing panel 140 can thus conduct heat from an adjacent burner into the base 112 of the vessel 110 and into the temperature sensor 130. Alternatively, the closing panel 140 can be of a material substantially different from the material of the vessel 110, such as a thermal isolator (e.g., a ceramic) to isolate the temperature sensor 130 and the electrical conductor 150 from substantially direct heat from the adjacent burner and/or to shield the temperature sensor 130 and the electrical conductor 150 from rapid temperature changes occurring across the base 112 of the vessel 110 when the apparatus 100 is placed over or removed from a hot burner. However, the closing panel 140 can be of any other suitable thermally-conductive or thermally-insulating material coupled to and retained against the base 112 of the vessel 110 in any other suitable way.

One variation of the apparatus 100 further includes a thermally-conductive material arranged between the temperature sensor 130 (and the electrical conductor iso) and the vessel 110. The thermally-conductive material can function to communicate heat from a region of the vessel 110 above into the temperature sensor 130 to reduce a temperature gradient from the interior surface of the vessel 110 to the temperature sensor 130. For example, the thermally-conductive material can include a metallic ceramic paste (i.e., viscous liquid), such as aluminum powder in a silicate-based binder, that is applied into the secondary recess 115 in the channel 114 before the temperature sensor 130 and/or the electrical conductor 150 are installed into the channel 114. The closing panel 140 can then be installed into the channel 114 to enclose the temperature sensor 130, the electrical conductor 150, and the thermally-conductive material. The assembly can then be baked, such as according to a time and temperature schedule, to cure the thermally-conductive material (e.g., convert the thermally-conductive paste into a solid thermally-conductive material). Alternatively, the apparatus 100 can be delivered to a user with the thermally-conductive material uncured, and the thermally-conductive material can then cure during a first use of the apparatus 100 to cook a dish (or a first few uses of the apparatus 100). The thermally-conductive material can additionally or alternatively be applied (e.g., potted) around the temperature sensor 130 between the temperature sensor 130 and the closing panel 140 to improve heat conduction from the exterior surface of the base 112 of the vessel 110 into the temperature sensor 130.

The thermally-conductive material can also exhibit a coefficient of thermal expansion (when cured) substantially similar to that of the closing panel 140 and the vessel 110.

One alternative variation of the apparatus 100 includes a thermal isolator interposed between the temperature sensor 130 and the closing panel 140. In this variation, the thermal isolator functions to thermally isolate the temperature sensor 130 (and the electrical conductor iso) from direct heating through the exterior surface of the base 112 of the vessel 110. For example, the thermal isolator can include a volume of thermally-insulating polymer 116—such as silicone—interposed between the temperature sensor 130 and the closing panel 140 and between electrical conductor 150 and the closing panel 140. The thermally insulating material can thus retard heat transfer from the exterior surface of the base 112 of the vessel 110 into the temperature sensor 130 such that elevated temperatures present along the heating surface of the vessel 110 have less impact on outputs of the temperature sensor 130. In particular, thermal energy entering the vessel 110 from the exterior surface of the base 112 of the vessel 110 (i.e., the “heating surface”) can move laterally around the thermal isolator before being conducted upward into the interior surface of the vessel 110 (i.e., the “cooking surface”); this thermal energy can then move laterally back toward the center of the cooking surface and then downward into the temperature sensor 130 below when the temperature sensor 130 outputs a signal corresponding to the local temperature of the vessel 110. The thermal isolator can also shield the electrical conductor 150 from direct heating by an adjacent burner below, thereby reducing heat conduction directly into the temperature sensor 130 via the electrical conductor 150.

Like the thermally-conductive material described above, the apparatus 100 can be shipped to a user with the thermal isolator cured or in an uncured state such that the thermal isolator cures within the first use or within the first few uses of the apparatus 100.

However, the apparatus 100 can include any other thermally-conductive material or thermal isolator of any other material and arranged in any other way within the apparatus 100.

### 1.5 Variations

As shown in FIG. 1B, one variation of the apparatus 100 includes a battery 170 arranged within the handle 120. Generally, the battery 170 functions to supply power to the wireless communication module 160 and/or to any other power circuit or component within the apparatus 100. As described above, the apparatus 100 can include one or more batteries installed behind a cover arranged on a distal end of the hand, and the cover can be removable to enable replacement of the battery 170 or batteries once substantially consumed. Alternatively, the battery 170 can be rechargeable, and a charging port arranged on the handle 120 can be configured to receive a charging plug to recharge the battery 170.

Alternatively, the apparatus 100 can include a thermoelectric generator thermally coupled to a sidewall of the vessel 110 and configured to convert thermal energy in the sidewall into electrical energy to power wireless communication module 160, the processor 180, and/or another electrical component within the apparatus 100. The thermoelectric generator can additionally or alternatively function to automatically recharge the battery 170 while the apparatus 100 is in use. Similarly, the apparatus 100 can include a photovoltaic solar cell arrange on (the top of) the handle 120 and configured to convert ambient light into electrical energy to power various components within the apparatus 100 and/or to recharge the battery 170.

Furthermore, one variation of the apparatus 100 includes an accelerometer 134 arranged within the handle 120, as shown in FIG. 1B. Generally, the apparatus 100 can output a signal corresponding to motion of the apparatus 100. The accelerometer 134 can be a single-axis or multi-axis accelerometer and can output a corresponding number of signals. A processor 180 within the apparatus 100 can then correlate a signal output from the accelerometer with a state or state change of the apparatus 100 or a state or state change of contents of the apparatus 100. For example, the processor 180 can determine if the apparatus 100 is static, if the apparatus 100 can be lifted off of or placed back onto a burner, if contents of the apparatus 100 are currently being stirred, if contents of the apparatus 100 are currently being flipped, etc. based on the output(s) of the accelerometer 134. Alternatively, the wireless communication module 160 can transmit a digital form of an output of the accelerometer 134 to the external computing device, and the native cooking guide application executing the method described below can remotely correlate the output of the accelerometer 134 with a state or state change of the apparatus 100 or contents of the apparatus 100.

The apparatus 100, can additionally or alternatively include a single- or multi-axis gyroscope, and a local processor in the apparatus 100 or the external device can similarly process an output of the gyroscope (or multiple outputs of the gyroscope over time) to state or state change of the apparatus 100 or contents of the apparatus 100.

As shown in FIG. 1B, one variation of the apparatus 100 includes a processor 180 arranged within the handle 120. Generally, the processor 180 controls various local functions of the apparatus 100, such as sampling the temperature sensor 130 when the apparatus 100 is in use, processing and/or extracting features from the temperature sensor 130 signal, and triggering transmission of raw and/or processed temperature data to the external computing device via the wireless communication module 160. For example, the processor 180 can be electrically coupled to the temperature sensor 130 via the electrical conductor 150, and the processor 180 can transform an analog output of the temperature sensor 130 into a digital value and then pass this digital value to the wireless communication module 160 for transmission to the external computing device. When the apparatus 100 is in use—such as when heat is applied to the vessel 110 or when the wireless communication module 160 is wirelessly connected or paired to an external computing device—the processor 180 can sample the temperature sensor 130 at a static or dynamic sampling rate, such as once per second (i.e., 1 Hz), and the wireless communication module 160 can transmit a raw or processed form of a temperature reading received from the temperature sensor 130 at a corresponding wireless transmission rate (e.g., 1 Hz). The processor 180 can also adjust the raw or processed temperature sensor 130 signal according to a calibration setting stored locally on the apparatus 100, and the wireless communication module 160 can thus transmit a calibrated form of the temperature sensor 130 output to the external computing device.

As in the variation of the apparatus 100 that includes an accelerometer, the processor 180 can sample the accelerometer 134 when the apparatus 100 is in use, process and/or extract features from the accelerometer signal, and trigger transmission of raw and/or processed acceleration data to the external computing device via the wireless communication module 160.

In one implementation, the processor 180 includes a power regulation circuit and a signal conditioning circuit. In this implementation, the signal conditioning circuit can apply a voltage across two leads the temperature sensor 130—via the electrical conductor 150—measures a resulting current passing through the temperature sensor 130, convert this current into an analog voltage at a transimpedance amplifier, and then convert this analog voltage into a digital value at an analog-to-digital converter. The signal conditioning circuit can be cycled on and off powered on and off to collect a temperature sample from the temperature sensor 130 intermittently, such as to extend a battery life of the apparatus 100 and to reduce self-heating at the temperature sensor 130 due to internal resistance, thereby yielding more accurate and repeatable temperature measurements from the temperature sensor 130. (Alternatively, the processor 180 can include a remote sensor unit arranged within the handle 120 and configured to wirelessly retrieve a temperature reading from the temperature sensor 130.) The processor 180 can also store digital values of temperature sensor 130 readings locally in internal memory or in memory arranged within the handle 120.

However, the processor 180 can control and handle data collection, processing, and/or storage locally on the apparatus 100 in any other suitable way.

### 1.5 Wireless Communication

The wireless communication module 160 is arranged within the handle 120, is coupled to the electrical conductor 150, and transmits a unique identifier and a value corresponding to an output of the temperature sensor 130 to an external computing device. Generally, the wireless communication module 160 functions to communicate temperature data (and acceleration and/or other data) collected locally at the apparatus 100 to the remote computing device for further processing and to triggering delivery of cooking-related prompts to a user.

The wireless communication module 160 can transmit (and receive) data to (and from) the external computing device over short-range wireless communication protocol, such as over Bluetooth or Wi-Fi. For example, the wireless communication module 160 can broadcast the unique identifier, temperature sensor 130 data, and/or other local data via a radio antenna arranged within the handle 120. The wireless communication module 160 can also interface with one or more intermediate communication nodes, such as IEEE 802.11 Wi-Fi including an access point or IEEE 802.14.5 Zigbee within a mesh network. The wireless communication module 160 can alternatively communicate with the external computing device over alternate communication channels, such as via encoded infrared transmission. However, the wireless communication module 160 can communicate with the external computing device over any other suitable wireless communication standard or protocol.

In one implementation, the wireless communication module 160 is operable between a first mode and a second mode. In the first mode, the wireless communication module 160 broadcasts a unique identifier at a first rate, such as at a static rate of twenty times per second (20 Hz). The unique identifier can be a static serial number assigned to the wireless communication module 160 or to the apparatus 100, a static wireless address assigned to the wireless communication module 160 or to the apparatus 100, or any other static value stored locally on and/or assigned to the wireless communication module 160 or to the apparatus 100 to enable the external computing device to wirelessly pair with the wireless communication module 160 within the apparatus 100. Alternatively, the wireless communication module 160 can broadcast a universally unique identifier (“UUID”), such as including a string of characters (e.g., a 128-bt hexadecimal number) in which the string of characters is practically unique (i.e., not guaranteed unique; the external computing device can then access a local or remote domain name system (“DNS”) to identify the apparatus 100. As described below, the method—executing on the external computing device—can trigger the computing device to pair with the wireless communication module 160 upon receipt of the unique identifier, such as based on a strength of the received signal. In a similar implementation, the wireless communication module 160 can broadcast a pairing request or a beacon signal to advertise the presence of the apparatus 100 to a local external computing device in the first mode, and the wireless communication module 160 can broadcast the unique identifier once a pairing process is initiated between the apparatus 100 and the external computing device. Once the wireless communication module 160 of the apparatus 100 is thus paired with the external computing device, the wireless communication module 160 can transition into the second mode.

In the second mode, the wireless communication module 160 can broadcast—at a second rate—a value corresponding to a substantially current output of the temperature sensor 130. For example, the wireless communication module 160 can broadcast values corresponding to outputs of the temperature sensor 130 at a rate corresponding to the sampling rate of the temperature sensor 130, such as at a second rate (e.g., 1 Hz) less than the first rate (e.g., 20 Hz). In the second mode, the wireless communication module 160 can broadcast a digital form of a raw temperature sensor 130 reading, a calibrated or normalized form of the temperature sensor 130 reading, calculated temperature change rates, and/or indicators of detected temperature events (e.g., transitions across specified temperature thresholds), etc.—paired with the unique identifier or other identifier of the wireless communication module 160 or the apparatus 100—to the remote computing device.

In the variation of the apparatus 100 that includes a battery 170, the wireless communication module 160 can further transmit—to the external computing device—a second value corresponding to a voltage of the battery 170. For example, in the second mode, the processor 180 (or a local analog-to-digital converter within the apparatus 100) can sample a voltage across the terminals of the battery 170 at the same sampling rate as the temperature sensor 130 and then transform this analog value into a digital value, and the wireless communication module 160 can transmit this (second) digital value to the external computing device along with an output of the temperature sensor 130 recorded at approximately the same time as the battery 170 voltage. Alternatively, the processor 180 can sample the battery 170 voltage at a rate greater than or less than the sampling rate of the temperature sensor 130, and, in the second mode, the wireless communication module 160 can broadcast the second value corresponding to the voltage of the battery 170 at a rate other than the transmission rate of the (first) value of the temperature sensor 130 output.

In the variation of the apparatus 100 that includes an accelerometer (or other motion or position sensor, such as a gyroscope or a tilt sensor), the wireless communication module 160 can additionally or alternatively transmit—to the external computing device—a third value corresponding to an output of the accelerometer 134. For example, in the second mode, the processor 180 can sample the accelerometer 134 at the same sampling rate as the temperature sensor 130 and then transform this analog accelerometer value into a digital value, and the wireless communication module 160 can transmit this (third) digital value to the external computing device along with an output of the temperature sensor 130 recorded at approximately the same time as the output of the accelerometer 134. Alternatively, the processor 180 can sample the accelerometer at a rate greater than or less than the sampling rate of the temperature sensor 130, and, in the second mode, the wireless communication module 160 can broadcast the third value corresponding to the output of the accelerometer 134 at a rate other than the transmission rate of the (first) value of the temperature sensor 130 output.

The wireless communication module 160 can also receive a command or data from the paired external computing device, such as a command to set a color of an indicator arranged on the apparatus 100. The wireless communication module 160 can also be powered by the battery 170 or by a thermal generator, as described above, or in any other suitable way.

However, the wireless communication module 160 can function in any other way establish a wireless connection to an external computing device (e.g., in the first mode) and to wirelessly communicate temperature, accelerometer, battery, and/or any other relevant data to the external computing device (e.g., in the second mode).

### 1.6 Visual Indicator

As shown in FIG. 1B, one variation of the apparatus 100 includes visual indicator that selectively exhibits an designator of the apparatus 100. Generally, the visual indicator functions to provide a visual (or tactile) cue to enable a user to distinguish the apparatus 100 from a similar apparatus 100 nearby based on a prompt or command received from the external computing device paired via the wireless communication module 160, such as if the user is cooking one or more dishes with multiple apparatus 100es as described herein. For example, the visual indicator can include a multi-color light source 190 arranged within the handle 120, the wireless communication module 160 can receive a color selection command from the external computing device, and the multi-color light source 190 can selectively output colored light according to the color selection received from the external computing device. In this example, the method—implemented within a native cooking guide application executing on the external computing device—can simultaneously track and deliver prompts for cooking two or more dishes in two or more corresponding apparatus woes, and the method can thus assign a color (e.g., red, blue, green, purple, etc.) to each recipe tracked and managed within the native cooking guide application, such as by shading a notification or prompt for a particular dish in a particular color assigned to the particular dish. In this example, the method can thus trigger the external computing device to transmit a command to set the color of a multi-color light source 190—arranged within a particular apparatus 100 corresponding to (i.e., containing) the particular dish—to the particular color. The visual indicator can thus update an output according to a prompt, command, or color assignment received from the external computing device to enable the user to (visually) match the apparatus 100 to a particular dish—of multiple dishes currently in process in multiple similar apparatus woes on a single stovetop—to corresponding prompts and notifications delivered to the user through an external computing device according to the method, as described below.

Alternatively, the handle 120 of the apparatus 100 can be color coded, and the method—executing within a native cooking guide application on the external device—can detect or identify the color of the handle 120 and apply a corresponding color filter to notifications or prompts associated with the dish cooking in the apparatus 100. For example, the handle 120 can be cast in a colored polymer (e.g., of red, green, blue, purple, or white nylon) or include a colored sleeve (e.g., of red, green, blue, purple, or white silicone), the color of the handle 120 can be stored as a color code in local memory in the wireless communication module 160, in local memory in the processor 180, or in discrete memory arranged within the handle 120, and the wireless communication module 160 can transmit the color code to the external computing device once the wireless communication module 160 and the external computing device are wirelessly paired. Alternatively, the color of the handle 120 (or any other component or surface of the apparatus 100) can be coded directly into the unique identifier transmitted by the wireless communication module 160, and the method—executing within the native cooking guide application—or a remote application server or database supporting the native cooking guide application can resolve a color code for the apparatus 100 directly from the unique identifier. Similarly, the method (or an application server supporting the native cooking guide application executing the method) can pass the unique identifier into a remote DNS and thus retrieve a corresponding color code for the apparatus 100.

Similarly, the apparatus 100 can include a visual indicator, such as one or more light emitting diodes (LEDs) (e.g., a red-green-blue LED), embedded in or coupled to the handle 120 and outputting a color of light corresponding to a temperature command received from the external computing device. For example, the processor 180 can trigger a red LED in the handle 120 to power “ON” in response to receipt of an over-temperature notification from the external computing device, the processor 180 can trigger a blue LED in the handle 120 to power “ON” in response to receipt of an under-temperature notification from the external computing device, and the processor 180 can trigger a green LED in the handle 120 to power “ON” in response to receipt of an proper temperature notification from the external computing device, such as if the temperature output from the temperature sensor 130 indicates that the temperature of the vessel 110 is within a suitable range of a target cooking temperature.

The visual indicate can alternatively include a liquid crystal display or any other suitable type of visual digital display. The apparatus 100 can additionally or alternatively include a speaker, a buzzer, or other audio driver arranged with the handle 120 and outputting auditory feedback to a user, such as cooking instructions or prompts stir the contents of the apparatus 100, to increase the vessel 110 temperature, and/or to decrease the burner temperature, etc.

### 2. Methods

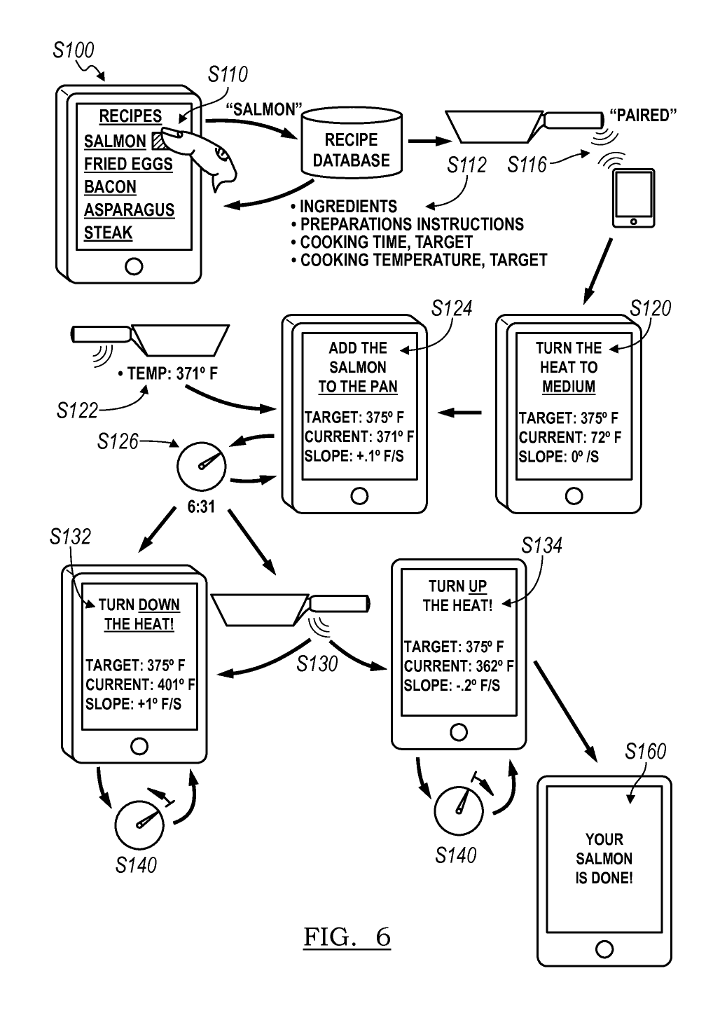

As shown in FIG. 6, a method for guiding cooking with a cooking vessel includes: on a computing device, receiving a selection for a recipe in Block S110; retrieving a target cooking time and a target cooking temperature for the recipe in Block S112; through the computing device, presenting a prompt to apply a level of heat to the cooking vessel in Block S120; receiving a first temperature measurement wirelessly transmitted from the cooking vessel in Block S122; in response to receiving the first temperature measurement within a threshold temperature range of the target cooking temperature, presenting, through the computing device, a prompt to add an ingredient of the recipe to the cooking vessel in Block S124; at a first time, in response to receiving the first temperature measurement within the threshold temperature range of the target cooking temperature, initiating a timer for a duration corresponding to the target cooking time in Block S126; at a second time, receiving a second temperature measurement wirelessly transmitted from the cooking vessel in Block S130; in response to receiving the second temperature measurement greater than the target cooking temperature, presenting, through the computing device, a prompt to reduce the level of heat in Block S132; in response to receiving the second temperature measurement less than the target cooking temperature, presenting, through the computing device, a prompt to increase the level of heat in Block S134; adjusting the duration of the timer based on a difference between the second temperature measurement and the target cooking temperature in Block S140; and, in response to expiration of the timer, indicating, through the computing device, completion of the recipe in Block S160.

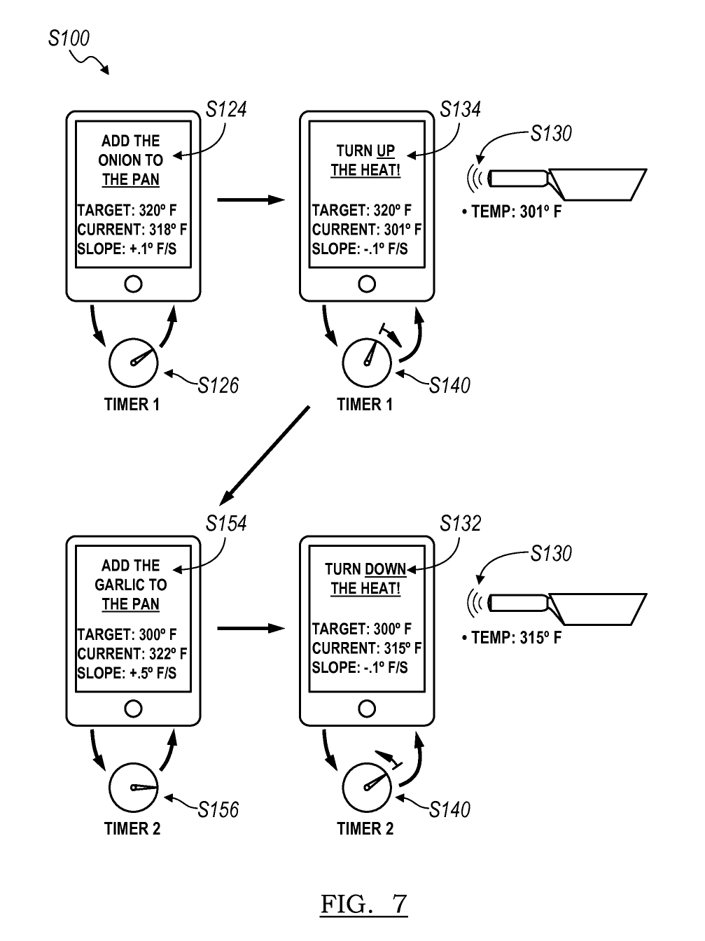

As shown in FIGS. 6 and 7, one variation of the method includes: on a computing device, receiving a selection for a dish in Block S110; retrieving a recipe for the dish, the recipe specifying a first ingredient, a second ingredient, a target cooking temperature, a first target cooking time corresponding to the first ingredient, and a second target cooking time corresponding to the second ingredient in Block S112; through the computing device, prompting application of a level of heat to the cooking vessel in Block S120; initiating a first timer for a duration corresponding to the first target cooking time in Block S126; through the computing device, prompting addition of the first ingredient to the cooking vessel in Block S124; at a first time, receiving a first temperature measurement wirelessly transmitted from the cooking vessel in Block S130; in response to receiving the first temperature measurement less than the target cooking temperature, prompting increase of the level of heat in Block S134; extending the duration of the first timer based on a difference between the first temperature measurement and the target cooking temperature in Block S140; in response to expiration of the first timer, prompting addition of the second ingredient to the cooking vessel in Block S154; initiating a second timer for a duration corresponding to the second target cooking time in Block S156; at a second time, receiving a second temperature measurement wirelessly transmitted from the cooking vessel in Block S130; adjusting a duration of the second timer based on the second temperature measurement in Block S140; and in response to expiration of the second timer, indicating, through the computing device, completion of the dish in Block S160.

As shown in FIGS. 6, 12, and 14, another variation of the method for guiding cooking with a cooking vessel includes: in a first mode: through a computing device, receiving a selection for a recipe in Block S110, retrieving, from a database of recipes, a target cooking time and a target cooking temperature for the recipe in Block S112, through the computing device, presenting a prompt to apply a level of heat to the cooking vessel in Block S120, and setting a cooking timer for a duration corresponding to the target cooking time in Block S126; in a second mode, receiving manual entry of a target cooking temperature through the computing device in Block S114; receiving a temperature measurement wirelessly transmitted from the cooking vessel in Block S130; in response to receiving the temperature measurement greater than the target cooking temperature, presenting, through the computing device, a prompt to reduce a level of heat applied to the cooking vessel in Block S132; in response to receiving the temperature measurement less than the target cooking temperature, presenting, through the computing device, a prompt to increase the level of heat application to the cooking vessel in Block S134; and, in the first mode: adjusting a duration of the cooking timer based on a difference between the second temperature measurement and the target cooking temperature in Block S140, and, in response to expiration of the timer, indicating, through the computing device, completion of the recipe in Block S160.

### 2.1 Applications

Generally, the method can be implemented on a remote computing device (e.g., a mobile computing device) wirelessly connected to (i.e., communicating with) a cooking vessel (e.g., the apparatus 100 described above) to monitor a cooking procedure and to deliver cooking-related prompts substantially in real-time based on real temperature data collected by and received from the cooking vessel in which a dish is cooking. For example, the method can be implemented within a native cooking guide application executing on mobile computing device, such as a smartphone or a tablet, wirelessly paired to the apparatus 100 described above to provide audible and/or visual guidance to a user in preparing ingredients for a dish, adding ingredients of the dish to a wireless-enabled frying pan (or other wireless-enable cooking vessel), reaching and maintaining a target cooking temperature(s) for the ingredients, and tracking a cooking time and/or heat exposure of the ingredients until the ingredients—and therefore the dish—are done cooking. In particular, the method can support or cooperate with an interface on the mobile computing device to receive a recipe selection from a set of available (public and/or private recipes), to provide details for preparing ingredients of the selected recipe, to receive and share with the user real temperature measurements received from the cooking vessel, to prompt the user to raise and lower an amount of heat applied to the cooking vessel to approximately achieve a target cooking temperature for the dish, to track (e.g., integrate) a heat exposure of the ingredients in the cooking vessel over time, and to inform the user that the dish is done when the actual (i.e., measured) heat exposure of the ingredients of the dish reaches the target heat exposure specified in the corresponding recipe.

Blocks of the method can be implemented locally within a native cooking guide application executing on a standalone computing device that is physically separate from the cooking vessel. Blocks of the method can support a user interface—accessible by a user through the computing device—to receive recipe selections, recipe instruction responses, ingredient information, etc. from the user and to present instructions and prompts to the user. The computing device can include a smartphone, a tablet, a laptop computer, or any other suitable type of standalone computing device. The computing device can also include a digital display and an input region, such as a touchscreen, through which select Blocks of the method provide instructions and prompts to the user and through which select Blocks of the method receive user selections and user responses to prompts. Select Blocks of the method can additionally or alternatively be implemented remotely, such as by an application server, at a remote database, or locally by the cooking vessel.

### 2.2 Recipe and Preparation

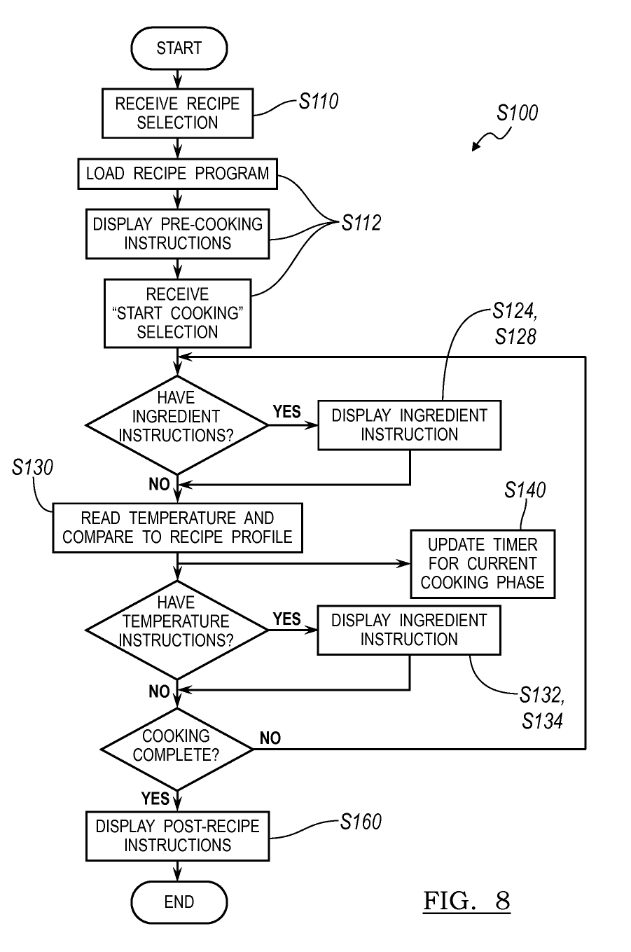

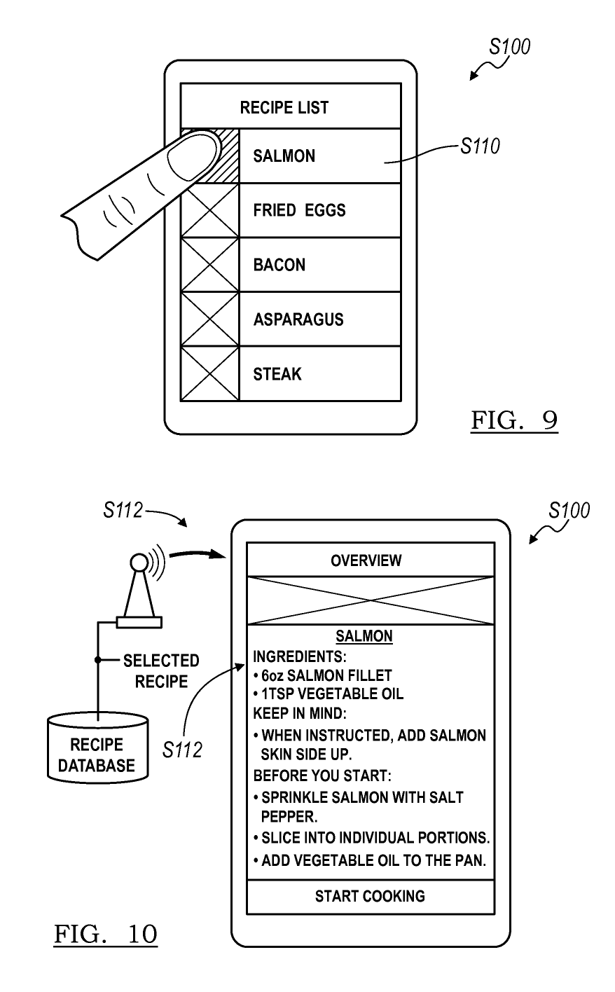

Block S110 of the method recites, on a computing device, receiving a selection for a recipe. Generally, Block S110 functions to receive, from a user, a selection for a dish to be cooked in a wireless-enabled cooking vessel, as shown in FIGS. 8 and 9.

In one implementation, once the native cooking guide application implementing the method is opened on the computing device and a user navigates to a menu to begin cooking a new dish, Block S110 retrieves a list of available public and/or private recipes, such as stored locally in memory on the computing device or remotely in a remote database. For example, Block S110 can retrieve—from local memory on the computing device—a first list of private recipes previously generated by the user and available to only the user (and to select other users selected by the user), and Block S110 can retrieve—from a remote database—a second list of public recipes available to all subscribers of the native cooking guide application, such as public recipes generated by professional chefs and published to the remote database of public recipes. In this example, Block S110 can render the first and second lists of recipes independently on a display of the computing device, or Block S110 can merge the first and second lists and present this merged list to the user through the display of the computing device. Block S110 can present each recipes in the first, second, and/or merged lists with a photo (e.g., a stock photo of the dish or a photo previously taken by the user upon previous completion of the dish), a title, a description, a prep time, and/or a review from one or more other users, etc.

Block S110 can support searching for a recipe via search terms, browsing by category, or browsing by user favorites, etc. Block S110 can also rank recipes in the first, second, and/or merged lists, such as based on recipes previously selected by the user, trending recipes among a group of users, the user's demographic or location, user-entered or predicted user tastes, etc.

Block S110 can thus receive selection of a particular recipe from the first, second, and/or merged list of recipes and then pass this recipe selection to Block S112.

Block S112 of the method recites retrieving a target cooking time and a target cooking temperature for the recipe. Generally, Block S112 functions to retrieve cooking parameters, an ingredient list, preparation instructions, and/or any other quantitative or qualitative data for the recipe selection captured in Block S110. For example, Block S112 can request recipe data from a remote database and download—from the remote database—all or a portion of a file corresponding to the selected recipe, such as shown in FIG. 10. Alternatively, Block S112 can retrieve relevant recipe data from local memory on the computing device.

In one implementation, Block S112 retrieves a digital recipe file specifying a single ingredient, a target cooking time for the ingredient, and a target cooking temperature for the ingredient. Alternatively, Block S112 can retrieve a digital recipe file specifying the single ingredient, a target cooking temperature for the ingredient, and a target heat exposure for the ingredient (e.g., the integral of the target heat exposure over a total target cooking time for the ingredient). Yet alternatively, Block S112 can retrieve a digital recipe file specifying the single ingredient, a target cooking temperature model for the ingredient, and a target heat exposure model for the ingredient, and subsequent Blocks of the method can apply one or more variables entered by the user—such as a thickness of a steak, a size of a potato, or a desired doneness—to calculate the target cooking time and target cooking temperature for the ingredient.

Block S112 can also retrieve a digital recipe file specifying multiple ingredients, a cooking schedule for the recipe (e.g., a cooking order for the ingredients), and a target cooking time and a target cooking temperature for each ingredient or group of ingredients. For example, Block S112 can retrieve a recipe that specifies a first ingredient, a second ingredient, a first target cooking temperature for the first ingredient, a second target cooking temperature for the second ingredient, a first target cooking time corresponding to the first ingredient, and a second target cooking time corresponding to the second ingredient.

A digital recipe file can therefore define multiple phases of the cooking procedure for the selected recipe. For example, a first ingredient or first set of ingredients can be cooked in the cooking vessel during a first phase of the recipe, a second ingredient or second set of ingredients can added to the cooking vessel and cooked with the first ingredient or first set of ingredients during a second phase of the recipe, and a third ingredient or third set of ingredients can added to the cooking vessel and cooked with the first and second ingredient or the first and second sets of ingredients during a third phase of the recipe. In this example, the digital recipe file can also specify a different target cooking temperature, a different target cooking time, and/or a different target heat exposure for each phase of the cooking procedure. Block S112 can thus retrieve a digital recipe file defining multiple cooking phases and various corresponding cooking parameters, and Block S112 can arm subsequent Blocks of the method to execute (e.g., implement, guide the user in implementing) the various cooking phases and corresponding cooking parameters accordingly.

Block S112 can also retrieve a set of preparation instructions for the recipe and can then render the ingredient list and the set of preparation instructions on the display of the computing device, as shown in FIG. 10. For example, Block S112 can present an overview of the selected recipe, an ingredient list and proportions, and preparation instructions (e.g., for chopping, dicing, or mixing ingredients), etc. within a user interface of the native cooking guide application rendered on the display of the computing device. Block S112 can also include presenting tips or suggestions for cooking the dish, such as a suggestion to first cook the meat side of a skin-on fish filet. Block S112 (in cooperation with one or more other Blocks of the method) can further present to the user—through the user interface of the native cooking guide application rendered on the display of the computing device—a projected time to prepare the ingredients before beginning the cooking procedure, a projected time to completion of the entire recipe program for the selected recipe, and/or a projected time until a major cooking step of the recipe, such as addition of an ingredient to the cooking vessel, a stirring step, a change in target cooking temperature, etc.

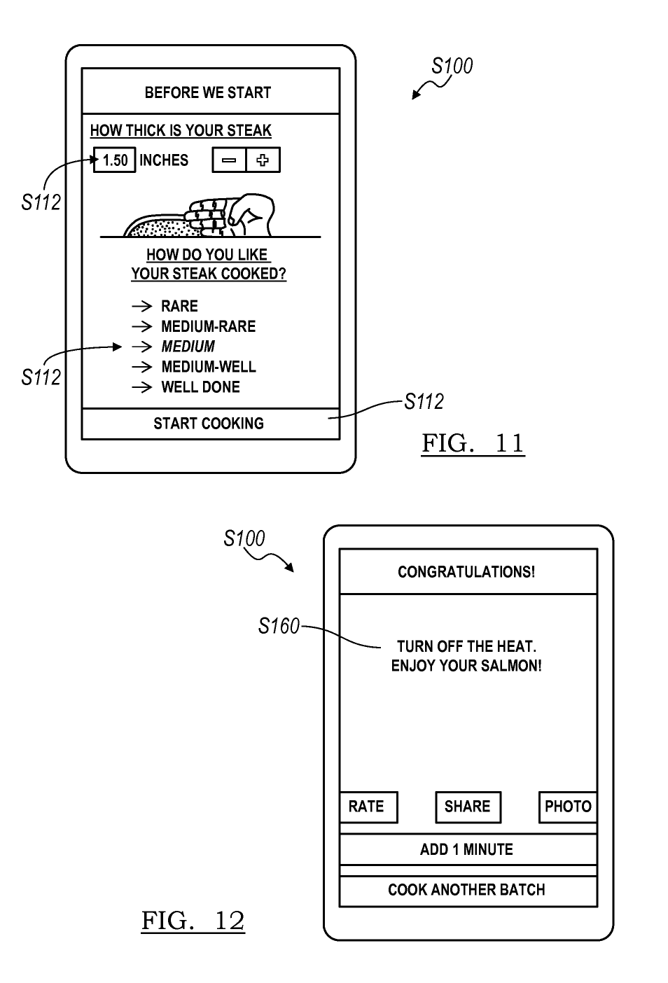

Certain digital recipe files collected in Block S112 can thus include one or more prompts related to cooking parameters for the corresponding dish, and Block S112 can prompt the user to answer the prompts before triggering Block S120 to begin the cooking procedure. In particular, Block S112 can prompt the user to enter a quantitative or qualitative cooking parameter before the cooking procedure begins. For example, for a steak recipe selected in Block S110, Block S112 can prompt the user to enter a thickness of a steak to be cooked and a desired doneness of the steak, such as shown in FIG. 11. In this example, Block S112 can render a virtual length rule on the display of the computing device to guide the user in determining a dimension (e.g., thickness) of an ingredient to be cooked, and Block S112 can render a text input region to receive a dimension entry from the user. Alternatively, Block S112 can prompt the user to select an ingredient dimensional from a list of preset dimensions, such as a discrete virtual dimension button adjacent the rendered virtual length rule. Yet alternatively, Block S112 can render a virtual representation of an ingredient, the user can pinch or expand the virtual representation of the ingredient through a touchscreen of the computing device until the size of the virtual representation of an ingredient matches the size of the real ingredient, and Block S112 can store this scale entry accordingly. Block S112 can thus collect a real dimension of the ingredient to be cooked, and Block S112 can apply the real dimension to a model for cooking time, a model for cooking temperature, and/or a model for heat exposure of the ingredient to calculate the target cooking temperature, the target cooking time, and/or the target heat exposure for the ingredient.

Block S112 can also prompt the user to add ingredients to or to remove ingredients from the recipe, such as when presenting the list of ingredients on the display of the computing device before the cooking procedure begins. For example, Block S112 can enable the user to replace olive oil with butter, replace wheat flour with brown rice flour, remove mushrooms, and double an amount of peas and broccoli in the recipe.

Block S112 can additionally or alternatively prompt the user to enter a scaling selection for the recipe. For example, Block S112 can receive—though a user interface rendered on the display of the computing device—a scaling selection for the recipe, such as to half or double the recipe, and Block S112 can then automatically modify the ingredient list and the set of preparation instructions for the recipe according to the scaling selection. Block S112 can also recalculate the target cooking time and the target cooking temperature for the recipe based on the scaling selection, such as to achieve the same target heat exposure for ingredients in the recipe regardless of the scale of the dish. In this implementation, Block S112 can also apply a minimum and/or a maximum scaling limit for the recipe. For example, Block S112 can calculate or access a maximum scaling factor for the recipe based on a known size of the cooking vessel and a known size of the ingredients, and Block S112 can apply the maximum recipe scale to a user's recipe scale entry to prevent possible overfilling of the cooking vessel with all of the ingredients of the scaled recipe, which may adversely effect heat exposure to the ingredients during the cooking procedure and yield unevenly-cooked food. In this example, Block S112 can calculate the maximum scaling factor for the dish based on a known dimension of the cooking vessel (e.g., as accessed or determined from the unique serial number transmitted from the cooking vessel), an order that the ingredients of the dish are added to the cooking vessel, a typical size change (e.g., shrinkage) of the ingredients during the cooking procedure (e.g., when additional ingredients are added to the cooking vessel), etc. such that the maximum scaling factor for the recipe accounts for both the size of the cooking vessel and the volumes of portions of the dish arranged in the pan over time during the cooking procedure. Block S112 can similarly calculate a minimum scaling factor for the recipe, such as to ensure that enough ingredient volume is contained within the cooking vessel to substantially limit a possibility of burning an ingredient or burning the cooking vessel at a target cooking temperature for the dish.

Block S112 can also collect barometric pressure data, altitude data, local ambient temperature or weather, and/or location data, etc., such as through a sensor integrated into the computing device or from a remote database or application server, and Block S112 can modify parameters of the recipe based on any of the environmental factors. For example, each recipe file in the public database of recipes can be normalized for cooking at sea level, and Block S112 can increase the target cooking time and reduce the target cooking temperature for the selected recipe based on the altitude of the computing device that is substantially above that sea level (e.g., at 2000+ feet above sea level), as determined by in Block S112 by cross-referencing a GPS location of the computing device with a topography map.

Once sufficient data is collected from the user to begin the cooking procedure, Block S112 can present to the user—through the user interface of the native cooking guide application rendered on the display of the computing device—a virtual “start button” to begin the cooking procedure. Block S112 can thus trigger Block S120 to begin the cooking procedure in response to selection of the virtual start button.

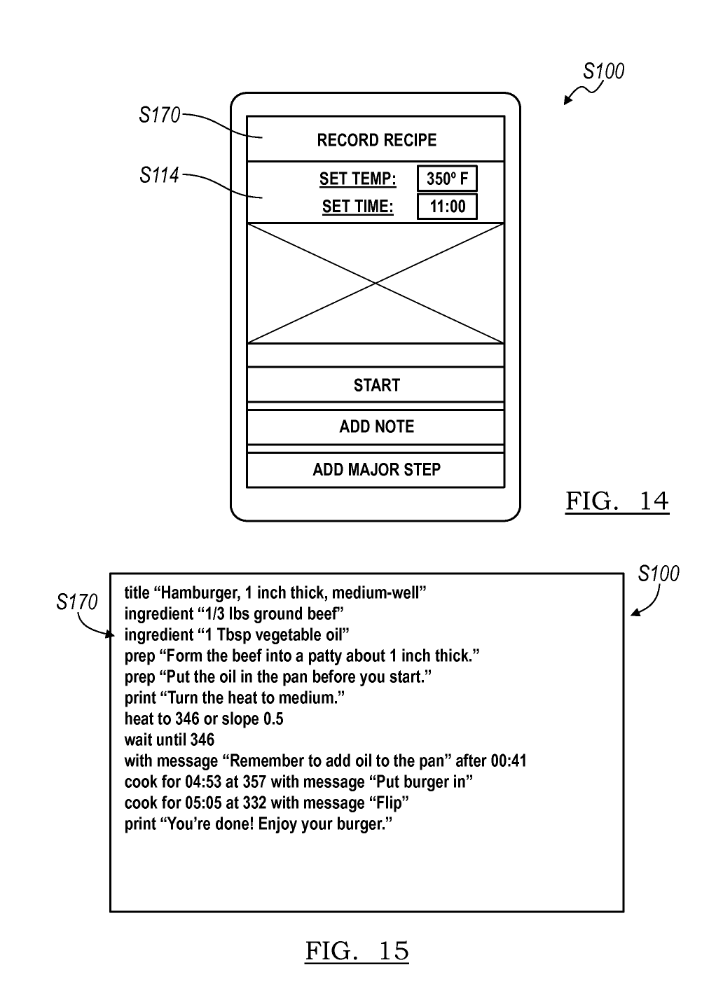

As shown in FIG. 14, one variation of the method includes Block S114, which recites, in a second mode, receiving manual entry of a target cooking temperature through the computing device. Generally, Block S114 functions to support a “free cooking” mode in which no recipe is selected and in which the method provides limited cooking-related guidance to the user, such as merely presenting prompts to adjust a heat on the cooking vessel to achieve a target temperature entered manually by the user and/or a timer for the cooking period. The method can thus enable the user to select between a first mode and a second mode, the method receiving a selection for a preset recipe (in Block S110) and guiding the user in completing the recipe in the first mode, and the method receiving a temperature and/or time selection and guiding the user in achieving the target temperature for the selected period of time in the second mode. For example, in the second mode, Block S114 can prompt a user to scroll through and to make a selection from a set of temperatures between 150° F. and 550° F. and then prompt the user to enter a time for a cooking timer. Block S114 can then pass these parameters to subsequent Blocks of the method to provide guidance to the user in achieving the selected time and temperature.

In the second mode, Block S114 can also prompt the user to record the upcoming cooking procedure, as shown in FIG. 14, and Block S114 can generate a new recipe file in response to election to record the upcoming cooking procedure. Block S114 can add the selected time and temperature to the new recipe file, and Block S114 can enable or intermittently prompt the user to enter an ingredient list, cooking instructions, notes, etc. before, during, and/or upon completion of the cooking procedure and further add these parameters to the new recipe file. Finally, Block S114 can maintain a private status of the new recipe file or publish the new recipe file to a public database of recipes based on a selection entered by the user to keep the new recipe file private or to publish the new recipe file.

One variation of the method includes Block S116, which recites, in response to receiving a manual entry of a prompt to begin cooking, qualifying a strength of a wireless signal received from the cooking vessel and wirelessly pairing the computing device to the cooking vessel based on the strength of the wireless signal. Generally, Block S116 functions to pair the computing device to the cooking vessel based on a strength of a wireless signal broadcast from the cooking vessel and received at the computing device. In particular, Block S116 can selectively pair the computing device to the cooking vessel based on signal strength of wireless communications with the cooking vessel to enable the user to select a particular cooking vessel from a group of cooking vessels within wireless range of the computing device. For example, once Block S112 receives a command to start the cooking procedure for the recipe, Block S116 can prompt the user to hold the computing device on or next to a handle of the cooking vessel, and Block S116 can thus trigger the computing device to wirelessly pair with the cooking vessel (e.g., the apparatus 100) from which a wireless signal of the greatest signal strength is received (i.e., the adjacent cooking vessel).

### 2.3 Cooking

Block S120 of the method recites, through the computing device, presenting a prompt to apply a level of heat to the cooking vessel. Generally, Block S120 functions to prompt the user to begin the cooking procedure for the selected dish by applying a heat source to the cooking vessel, such as in response to successful wireless pairing between the computing device and the cooking vessel. For example, Block S120 can present to the user—through the user interface of the native cooking guide application rendered on the display of the computing device—a prompt to turn on or light an adjacent burner of the stovetop to begin heating the cooking vessel. Block S120 can also select a level of heat to initially apply to the cooking vessel based on the target cooking temperature. For example, Block S120 can select a “low heat” level if the (first) target temperature specified in the recipe is 250° F.±50° F., Block S120 can select a “medium heat” level if the (first) target temperature specified in the recipe is 350° F.±50° F., and Block S120 can select a “high heat” level if the (first) target temperature specified in the recipe is 450° F.±50° F.; Block S120 can then communicate a prompt (e.g., a visual prompt and/or an audible prompt) for the user to select a low, medium, or high burner temperature accordingly.

Block S120 can also render a current temperature measurement received from the cooking vessel in Block S122, as described below, and a target temperature of the cooking vessel at which the first ingredient(s) will the added thereto. Block S120 can further present to the user an audible and/or a visual prompt to add a fat to the cooking vessel, such as an amount of butter, olive oil, coconut butter, or bacon grease to grease the cooking vessel. However, Block S120 can provide any other suitable prompt in any other suitable format to guide the user in beginning the cooking procedure for the selected recipe.

Block S122 of the method recites receiving a first temperature measurement wirelessly transmitted from the cooking vessel. Generally, Block S122 can interface with a wireless communication module within the computing device to download—from the paired cooking vessel (e.g., the apparatus 100)—a value corresponding or related to a recent output of a temperature sensor arranged within the cooking vessel, as described above. Block S122 can download from the cooking vessel a digital value corresponding to a raw output of the temperature sensor in the cooking vessel, a digital value corresponding to a calibrated output of the temperature sensor in the cooking vessel, or a value corresponding to any other form of temperature measurement from the cooking vessel.

Block S122 can cyclically receive temperature readings from the cooking vessel, such as at a rate of one reading per second (1 Hz) as readings are collected by and broadcast from the cooking vessel. Block S122 can also update a temperature indicator rendered within the user interface display on the computing device substantially in real-time upon receipt of each temperature reading from the cooking vessel.

Block S124 of the method recites, in response to receiving the first temperature measurement within a threshold temperature range of the target cooking temperature, presenting, through the computing device, a prompt to add an ingredient (e.g., the first ingredient) of the recipe to the cooking vessel. Generally, Block S124 functions to deliver and audible and/or a visual notification to prompt the user to add a first ingredient of the dish to the cooking vessel once the temperature of the cooking vessel reaches a suitable temperature, such as once Block S122 reaches a temperature reading from the cooking vessel indicating that the cooking vessel has reached a temperature within a suitable range of the target temperature for the first ingredient.

Block S124 can further include extrapolating a rate of temperature change of the cooking vessel based on temperature readings received from the cooking vessel over time in Block S122 and delay delivery of the prompt to add the first ingredient to the cooking vessel if the rate of temperature change of the cooking vessel indicates a probability of a substantial over-temperature event or under-temperature event. Therefore, Block S124 can deliver the prompt to add the first ingredient of the cooking vessel only once the temperature of the cooking vessel is within a threshold range of the target temperature at a time at which an absolute rate of change of the temperature of the cooking vessel is less than a threshold temperature change rate. However, Block S124 can function in any other way to prompt the user to add an ingredient to the cooking vessel.

Block S124 can also prompt the user to confirm that the ingredient was added to the cooking vessel. For example, Block S124 can render an open box adjacent a textual prompt to add the first ingredient to the cooking vessel shown within the user interface rendered on the computing device, and Block S124 can (implicitly or explicitly) prompt the user to confirm that the first ingredient was added to the cooking vessel by selecting (e.g., checking, crossing out) the open box. Once confirmation that the ingredient was added to the cooking vessel in thus received, Block S124 can trigger Block S126 to initiate a timer for cooking the ingredient.

Block S126 of the method recites, at a first time, in response to receiving the first temperature measurement within the threshold temperature range of the target cooking temperature, initiating a timer for a duration corresponding to the target cooking time for the dish. Similarly, Block S126 can recite initiating a first timer for a duration corresponding to the first target cooking time. Generally, Block S126 functions to initiate a cooking timer once the prompt to add the first ingredient is delivered to the user in Block S124 or once Block S124 receives confirmation that the first ingredient was added to the cooking vessel.

In one implementation, Block S126 initiates a global cooking timer corresponding to a total cooking time for the dish. For example, if the selected recipe file specifies that the dish will be fully and properly cooked in twelve minutes and fifteen seconds if the target temperature is perfectly maintained during the cooking procedure, Block S126 can set the timer to countdown from twelve minutes and fifteen seconds. In this implementation, Block S126 can retrieve the total cooking time from the recipe file or calculate the total cooking time by summing duration of individual cooking events during the cooking procedure, such as a target cooking time for a first ingredient at a first target temperature and a target cooking time for a second ingredient—added to the cooking vessel after the first ingredient—at a second target temperature.

Block S126 can also render a clock within the user interface shown on the display of the computing device and update the clock according to the timer throughout the cooking procedure.

### 2.4 Guidance

Block S130 of the method recites, at a second time, receiving a second temperature measurement wirelessly transmitted from the cooking vessel. Generally, Block S130 functions like Block S122 to download one or a series of temperature readings from the cooking vessel once the first ingredient is added to the cooking vessel and begins cooking.

Block S132 of the method recites, in response to receiving the second temperature measurement greater than the target cooking temperature, presenting, through the computing device, a prompt to reduce the level of heat, and Block S134 of the method recites, in response to receiving the second temperature measurement less than the target cooking temperature, presenting, through the computing device, a prompt to increase the level of heat. Generally, Block S132 and Block S134 cooperate to deliver (audible and/or visual) prompts to the user to adjust a level of heat applied to the cooking vessel to better achieve the target cooking temperature specified for the full duration or for a current cooking phase of the cooking procedure for the selected dish. In particular, Block S132 delivers a prompt to the user to lower the level of heat applied to the cooking vessel if the temperature received from the cooking vessel exceeds the target cooking temperature specified for the recipe (or for the current phase of the cooking procedure), such as by a threshold temperature (e.g., +5° F. for a target temperature of 250° F.±50° F., +10° F. for a target temperature of 350° F.±50° F., and +20° F. for a target temperature of 450° F.±50° F.). Similarly, Block S134 delivers a prompt to the user to increase the level of heat applied to the cooking vessel if the temperature received from the cooking vessel is substantially less than the target cooking temperature specified for the recipe (or for the current phase of the cooking procedure), such as by the threshold temperature (e.g., −5° F. for a target temperature of 250° F.±50° F., −10° F. for a target temperature of 350° F.±50° F., and −20° F. for a target temperature of 450° F.±50° F.). However, Blocks S132 and S134 can apply any other static or dynamic temperature difference thresholds to trigger such prompts in response to deviation of a received temperature of the cooking vessel from a current target cooking temperature.

Blocks S132 and S134 can also visually and/or audibly inform the user of the target cooking temperature for the current cooking phase, the actual temperature of the cooking vessel, and/or a difference between the actual and target temperatures, etc. For example, Block S132 can update the user interface rendered on the computing device to show that the target cooking temperature is 310° F. and that the actual temperature of the computing device is 328° F., and Block S132 can further trigger intelligent personal assistant software executing on the computing device to audibly recite the message, “Turn down the heat.” In a similar example, Block S134 can update the user interface rendered on the computing device to show that the target cooking temperature is 310° F. and that the actual temperature of the computing device is 291° F., and Block S134 can further trigger the intelligent personal assistant software to audibly recite the message, “Turn up the heat.”

Blocks S132 and S134 can deliver similar prompts to the user to lower and to raise the level of heat, respectively, based on a rate of change of temperatures readings received from the cooking vessel (e.g., in Block S130) over time. For example, Block S130 can receive temperature readings from the cooking vessel over time at a rate of one temperature reading per second and can calculate a temperature change rate across sequential temperature readings based on a difference between the temperature readings and a time interval between the temperature readings, and Blocks S132 and S134 can deliver prompts to the user in response to the current calculated temperature change rate that exceeds a threshold temperature change rate, either independently of a current temperature reading received from the cooking vessel, in addition to the current temperature of the cooking vessel, and/or in addition to difference between the current temperature of the cooking vessel and the target cooking temperature. In particular, Block S130 can calculate a derivative (i.e., slope, rate) of the change in temperature of the cooking vessel (as measured by the temperature sensor arranged within the cooking vessel) over time across two or more temperature readings and predict a potential significant over-temperature or under-temperature event at the cooking vessel based on the rate of change of temperature readings received from the cooking vessel, and Blocks S132 and S134 can selectively deliver prompts to the user to adjust the level of heat applied to the cooking vessel to preempt (significant) over- and under-temperature events. Block S130 can also render the calculated temperature change rate (i.e., slope) within the user interface displayed on the computing device.

In the foregoing variation, Block S130 can further predict a type of stovetop range currently heating the cooking vessel based on the calculated temperature change rate. For example, Block S130 can correlate a profile of the rates of temperature changes measured at the cooking vessel with one of a gas flame (which may yield a substantially linear change in temperature from a first temperature to a second temperature), an electric resistive heating element (which may yield a substantially sinusoidal change in temperature from a first temperature to a second temperature), an electric radiant heating element, or an electric inductive heating element embedded in the cooking vessel. For example, Block S122 and Block S130 can cooperate to collect temperature readings from the cooking vessel from the point at which the cooking vessel is first exposed to heat at a first time up to a second time at which the temperature of the cooking vessel reaches the target cooking temperature, and Block S130 can then match the slope of the temperature curve from the first time to the second time to a temperature change model of one of a gas flame, an electric resistive heating element, an electric radiant heating element, or an electric inductive heating element embedded in the cooking vessel. Block S130 can thus set or select threshold differences between actual and target temperatures of the cooking vessel and/or threshold temperature change rates to target delivery of a temperature decrease prompt in Block S132 or a temperature increase prompt in Block S134 based on the determined range type.

Blocks S132 and S134 can further monitor a strength of a wireless signal received from the cooking vessel, correlate a current strength of the wireless signal with a proximity of the computing device to the cooking vessel, and set temperature and/or temperature change rate thresholds for triggering delivery of heat adjustment prompts to the user. For example, Blocks S132 and S134 can implement low threshold temperature differences between the actual and target temperatures of the cooking vessel to trigger prompts to adjust the level of heat on the cooking vessel when the computing device is substantially close to the cooking vessel (i.e., when the wireless signal strength is high), and Blocks S132 and S134 can implement high threshold temperature differences between the actual and target temperatures of the cooking vessel to trigger such prompts when the computing device is relatively far away from the cooking vessel (i.e., when the wireless signal strength is low).

Other Blocks of the method can similarly time delivery of notifications—such as of an upcoming step in the cooking procedure—according to the proximity of the computing device to the cooking vessel, such as determined from a strength of a wireless signal received from the cooking vessel. For example, Block S154 can deliver a prompt to add a second ingredient to the cooking vessel immediately upon expiration of a first phase of the cooking procedure and upon initiation of a second phase of the cooking procedure when the computing device is substantially close to the cooking vessel (i.e., when the wireless signal strength is high), and Block S154 can deliver the prompt to add the second ingredient to the cooking vessel one minute before expiration of the first phase of the cooking procedure (i.e., one minute before initiation of the second phase of the cooking procedure) when the computing device is substantially removed from the cooking vessel (i.e., when the wireless signal strength is low).

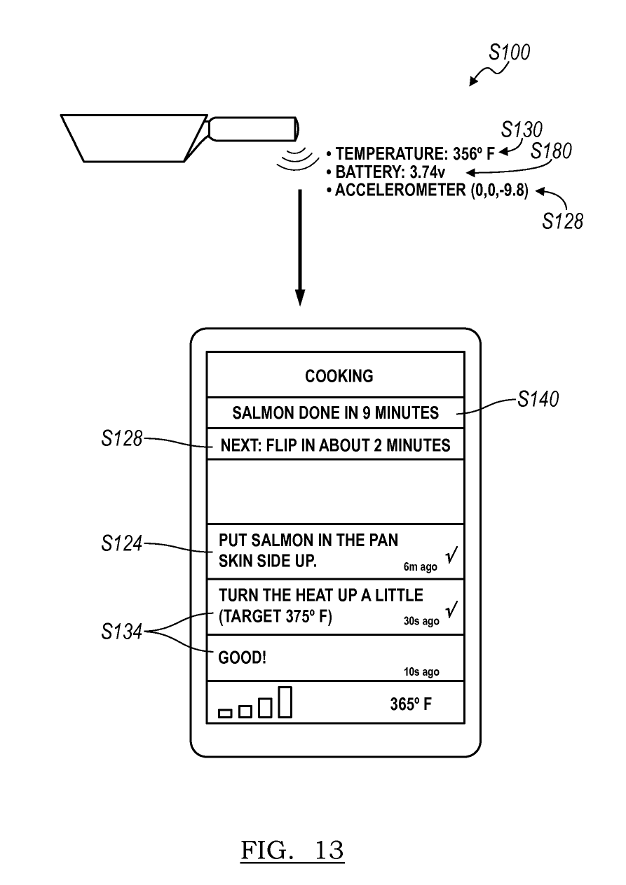

Blocks S132 and S134 can further cooperate to deliver positive feedback to the user when the cooking procedure is followed without substantially deviation from the cooking procedure specified for the selected recipe. For example, Blocks S132 and S134 can cooperate to deliver a notification reciting, “Good job! You're maintaining the correct temperature very well,” as shown in FIG. 13 However, Blocks S130, S132, and S134 can function in any other way to track the temperature of the cooking vessel and to present prompts to the guide the user in achieving a target cooking temperature for a current phase of the cooking procedure in both the first mode and the second mode of the method.

### 2.5 Compensation

Block S140 of the method recites adjusting the duration of the timer based on a difference between the second temperature measurement and the target cooking temperature. Generally, Block S140 functions to monitor a heat exposure of an ingredient cooking in the cooking vessel over time, to extend the target (or calculated) cooking time for the ingredient (e.g., by adding time to a timer for the current phase of the cooking procedure) if the actual temperature of the cooking vessel is less than the target cooking temperature, and to shorten the target cooking time for the ingredient (e.g., by removing time from the current phase of the cooking procedure) if the actual temperature of the cooking vessel is greater than the target cooking temperature.

In one implementation, in the first mode, Block S140 can calculating a target heat exposure of the ingredient up to a current time during the cooking procedure by integrating the target temperature over a time duration between a first time at which the ingredient was added to the cooking vessel and the current time. In this implementation, Block S140 can then calculate a real heat exposure of the ingredient up to the current time by integrating a sequence of temperature measurements received from the cooking vessel between the first time and the current time according to a time interval between receipt of each temperature measurement. If the real heat exposure does not match the target heat exposure for the current time, Block S140 can adjust or reset the timer (e.g., for the whole cooking procedure, for a the current cooking phase) accordingly. For example, Block S140 can calculate a total target heat exposure for the ingredient for the whole cooking procedure or for the current cooking phase, such as based on the target cooking time and target cooking temperature for the recipe or for the current phase of the cooking procedure for the recipe, calculate a difference between the heat exposure of the ingredient up to the current time and the total target heat exposure for the ingredient, and calculate a new time for the timer by dividing the difference by the current temperature measurement received from the cooking vessel. Block S140 can repeat this procedure for each new temperature measurement received from the cooking vessel or intermittently throughout the cooking procedure, as shown in FIG. 8. Block S140 can then update a clock rendered on the display according to the status of the new or adjusted timer.

Block s140 can implement similar methods and techniques in the second mode to shorten or extend a cooking time set by the user based on differences between a target temperature entered by the user and actual temperatures of the cooking vessel recorded during the cooking period.

### 2.6 Secondary Cooking Steams

As shown in FIG. 7, one variation of the method includes Block S154, which recites, in response to expiration of the first timer (corresponding to a first cooking phase for a first ingredient of the recipe), prompting addition of a second ingredient to the cooking vessel. Generally, Block S154 functions to deliver an audible and/or visual (e.g., textual) prompt to the user to add the second ingredient or second set of ingredients of the recipe to the cooking vessel upon expiration of a cooking time (i.e., the first cooking timer) for the first ingredient or first set of ingredients of the recipe. Blocks S124 and S154 can therefore cooperate to intermittently supply prompts to the user to add particular ingredients to the cooking vessel according to a cooking schedule for the recipe, wherein Block S124 initiates the first phase of the cooking procedure to (partially) cook the first ingredient(s), and wherein Block S154 initiates the second phase of the cooking procedure to (partially or fully) cook the first ingredient(s) and the second ingredient(s).

Block S154 can also deliver a prompt to the user to adjust the level of heat applied to the cooking vessel based on a second target temperature corresponding to the second phase of the cooking procedure. For example, Block S154 can update a target temperature value—rendered in the user interface of the native cooking guide application shown on the computing device—to depict a new target temperature for the second phase of the cooking procedure (e.g., a second temperature corresponding to the second ingredient).

As shown in FIG. 7, the foregoing variation of the method can further include Block S156, which recites initiating a second timer for a duration corresponding to the second target cooking time. Generally, Block S156 can implement methods and techniques similar to those of Block S126 to initiate a second timer corresponding to the second cooking phase of the cooking procedure. Blocks S130, S132, S134, and S140 can thus repeat during the second phase of the cooking procedure according to target cooking times and target cooking temperatures, etc. of the second ingredient(s) to provide further guidance to the user to finish the dish. For example, Block S130 can receive a third temperature measurement wirelessly transmitted from the cooking vessel at a second time; Block S134 can present, through the computing device, a prompt to increase the level of heat in response to receiving the third temperature measurement less than the second target cooking temperature; and Block S140 can extend the duration of the timer for the whole cooking procedure (or a second timer specific to the second cooking phase) based on a difference between the third temperature measurement and the second target cooking temperature, as shown in FIG. 7.

Alternatively, Blocks S154, S156, S130, S132, S134, and S140 can cooperate to guide the user in fulfilling a second phase of the cooking procedure for the same ingredient (e.g., the first ingredient, the first set of ingredients). For example, Blocks S124, S126, S130, S132, S134, and S140 can cooperate to guide the user in searing the outside of a steak at a relatively high first temperature; and Blocks S154, S156, S130, S132, S134, and S140 can cooperate to guide the user in cooking the steak through at a lower second temperature until a desired doneness is achieved for the user-entered steak thickness.

### 2.7 Agitation

As shown in FIG. 13, one variation of the method includes Block S128, which recites rendering, on a display of the computing device, a prompt to stir contents of the cooking vessel and receiving, through the computing device, confirmation of completion of a stirring procedure. Generally, Block S128 functions to deliver a prompt—through the computing device—to agitate contents of the cooking vessel. For example, Block S128 can render a textual instruction and/or audibly output a prompt to stir contents of the cooking vessel, to flip contents of cooking vessel (e.g., a steak filet), to whisk contents of the cooking vessel (e.g., eggs for a scrambled egg recipe), etc. In this variation, Block S128 can further prompt the user to provide confirmation that the agitation instruction was fulfilled. For example, Block S128 can (implicitly or explicitly) prompt the user to check off an empty box adjacent a textual form of the agitation instruction rendered on a touchscreen of the device to indicate that the agitation instruction was fulfilled. However, Block S128 can deliver an agitation instruction for any other suitable type of agitation in any other suitable way.

In this variation, Block S128 can further communicate with the cooking vessel over wireless communication protocol to retrieve (a form of) motion data output from an accelerometer or other motion sensor arranged within the cooking vessel. For example, the cooking vessel can monitor outputs of an integrated accelerometer during the cooking procedure and transmit a flag to the computing device each time a (composite) magnitude of the accelerometer exceeds a threshold acceleration for a threshold period of time. In another example, the cooking vessel can characterize outputs of the integrated accelerometer as one of a set of motion types, such as by matching outputs of the integrated accelerometer to one of a various models of motion types stored locally in memory in the cooking vessel. In this example, the cooking vessel can match oscillating accelerometer outputs along two horizontal axes of the cooking vessel over a period of at least two seconds with stirring, and the cooking vessel can extrapolate a roughly circular motion of the cooking vessel approximately along a vertical plane from accelerometer data collected from the integrated accelerometer over a time of between half and five seconds and match this circular motion with a flipping action; the cooking vessel can thus transmit values corresponding to these motion types to the computing device, and Block S128 can process these values to automatically determine if the user fulfilled an agitation prompt. Alternatively Block S128 can receive raw of filtered accelerometer data (or data from any other motion sensor arranged within the cooking vessel) and similarly process these data (e.g., locally on the computing device or remotely on an application server, in real-time or asynchronously) to characterize a type of agitation occurring at the cooking vessel. The cooking vessel and/or Block S128 can additionally or alternatively collect and process output data from a gyroscope, a tilt sensor, and/or any other suitable sensor integrated into the cooking vessel to identify and characterize any other type of agitation occurring at the cooking vessel.

In the foregoing implementation, Block S128 can thus automatically determine that an agitation instruction previously delivered to the user was fulfilled. For example, Block s128 can automatically check an empty box rendered on the display adjacent a textual prompt to stir the contents of the cooking vessel if motion data received from the cooking vessel substantially matches a stirring model stored in memory on the computing device.

The cooking vessel (e.g., the apparatus 100) can also cyclically sample the integrated accelerometer (or other motion sensor), such as at a rate of once per second (1 Hz) and transmit corresponding raw, filtered, or processed data to the computing device, and Block S128 can monitor this motion data throughout the cooking procedure to identify instances in which the cooking vessel is being over-agitated (e.g., instances in which the contents of the cooking vessel are being stirred too much). In this implementation, Block S128 can also deliver a prompt to the user—through the computing device—to cease agitation.

### 2.8 Recipe Completion

Block S160 of the method recites, in response to expiration of the timer, indicating, through the computing device, completion of the recipe. Generally, Block S160 functions to deliver an audible and/or visual prompt to the user to remove the cooking vessel from heat according to completion of the cooking procedure for the recipe, such as indicated by expiration of the timer or expiration of a timer specific to a final cooking phase of the cooking procedure, as shown in FIG. 12.

In one example, Block S160 renders on the display of the computing device—a completion screen to congratulates the user in completing the dish. Block S160 can also deliver audible and/or visual give post-cooking instructions, such as plating instructions for the dish, through the computing device. Block S160 can also render—on the display of the computing device—a virtual button to add an additional minute to the cooking time, as shown in FIG. 12, and Blocks S130, S132, and S134 can cooperate to guide the user in achieving the final target cooking temperature until the additional minute expires, at which point Block S160 can repeat to again indicate completion of the recipe to the user through the computing device.

Block S160 can further prompt the user to capture a digital photo of the dish, with the computing device, upon completion of the cooking procedure, as shown in FIG. 12, and Block S160 can store the corresponding image locally on the computing device, remotely in a database private to the user, and/or in a remote database with public photos of various recipes completed by various users. Block S160 can further publish the digital image to a social network.

Block S160 can also render a virtual prompt to repeat the recipe (i.e., to cook a second batch of the dish), and Block s160 can trigger Block S112 to repeat to again provide preparation instructions for the selected recipe before Block S120 again prompts the user to apply a level of heat to the cooking vessel according to the cooking procedure for the selected recipe.

### 2.9 Recording Recipes

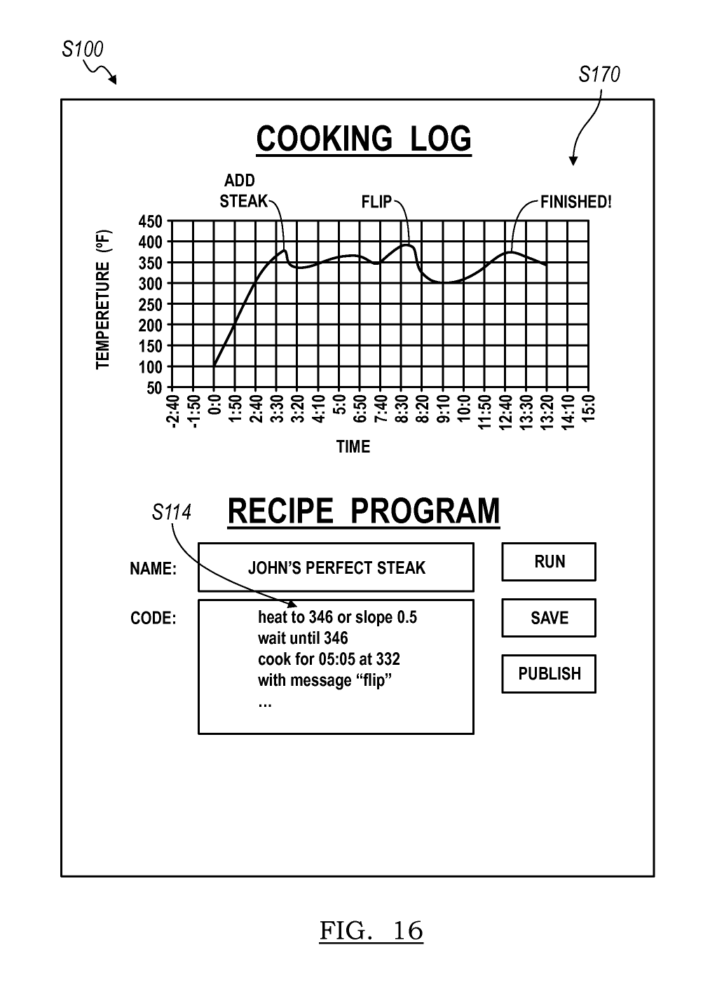

As shown in FIG. 16, one variation of the method includes Block S170, which recites, in the second mode, recording the target cooking time, the target cooking temperature, the temperature measurement, a final duration of the timer, and a recipe instruction entered manually into the computing device and generating a private recipe based on the target cooking time, the target cooking temperature, the temperature measurement, the final duration of the timer, and the recipe instruction. Generally, Block S170 functions to record cooking vessel temperature and cooking event data during a “free cooking” mode (i.e., the second mode) such that these recorded details of the cooking procedure performed by the user can be recalled at a later date to guide the user in repeating the cooking procedure.

In one implementation, Block S170 cooperates with Blocks S130, S140, and/or S128, etc. to record temperatures of the cooking vessel and corresponding times throughout the cooking procedure, such as one temperature and corresponding time relative to the start of the cooking procedure per second during the cooking procedure. Block S170 can also record annotations manually entered by the user, such as before the cooking procedure begins, in real-time during the cooking procedure, and/or upon completion of the cooking procedure, as shown in FIG. 15. For example, Block S170 can record an ingredient list, ingredient preparation instructions, a schedule for adding ingredients to the cooking vessel, agitation instructions, plating instructions, etc. entered manually by the user into the user interface rendered on the display of the computing device. Block S170 can thus automatically generate an annotated temperature profile, including any of the foregoing data arranged in sequence according to their corresponding times during the cooking procedure, as shown in FIG. 16, and Block S170 can then automatically transform the annotated temperature profile into a new private recipe program accessible by the user and/or a new public recipe program accessible by other users to repeat the cooking procedure again in the future. For example, Bock S170 can generate a two-dimensional chart of a cooking procedure within time on the X-axis of the chart, cooking temperature along the Y-axis of the chart, and user-entered annotations interspersed along the time axis of the chart to indicate when a steak was added to the cooking vessel, when the steak was flipped, and when the cooking vessel was removed from a heat source, thus indicating that the steak was done, as shown in FIG. 16); Block S170 can publish this chart as a new recipe in a public or private recipe repository to enable the user to modify the recipe, add additional notes or annotations to the recipe, and/or repeat the recipe at a future date.

Block S170 can thus store the annotated temperature profile and/or the new recipe program, such as in a local or remote recipe repository or log database of recorded cooking procedures (or “cooking sessions”) completed by the user. The user can access the log database through the native cooking guide application, through a web browser, or through any other user interface on any suitable computing device to review time and temperature data for one or more previous cooking procedures performed by the user (and/or various other users). At a later date, Block S110 can exhibit the new recipe in a list of available public and/or private recipes, and Block S112 can retrieve temperature, time, ingredient, and/or other data from the new recipe program when the new recipe program is selected by the user.

### 2.10 Cooking Vessel Maintenance

As shown in FIG. 13, one variation of the method includes Block S180, which recites receiving, from the cooking vessel, a value corresponding to a voltage of a battery arranged within the cooking vessel and rendering, on a display of the computing device, a stage of charge of the battery based on the value. Generally, Block S180 functions to download a value—corresponding to the voltage of a battery arranged within the cooking vessel—from the cooking vessel, to calculate a state of charge of the battery in the cooking vessel based on the value, and to present state of charge of the battery through the computing device. For example, the cooking vessel can transmit to the computing device a digital value corresponding to the analog voltage across the terminals of the battery, Block S180 can translate the digital value into a state of charge of the battery, and Block S180 can then update a battery icon rendered within the user interface on the computing device to indicate to the user the state of charge of the battery within the cooking vessel. Block S180 can additionally or alternatively deliver an audible and/or visual prompt to the user to replace or recharge the battery when the determined state of charge of the battery drops below a threshold state of charge, such as when the calculated capacity of the battery drops 5% of the capacity of the battery when fully-charged.

### 2.11 Multiple Recipes

The method can support a cooking procedure for each of a set of recipes substantially simultaneously, and the method can thus guide a user in cooking multiple dishes simultaneously. Multiple instances of the foregoing Blocks of the method can therefore execute in parallel on the computing device. For example, a first instance of Block S110 can receive a selection for a stir fry dish, a first instance of Block S112 can retrieve a recipe for the stir fry dish, and first instances of Blocks S120, S122, S124, S130, S132, S134, etc. can cooperate to guide the user in cooking the stir fry dish in a first wireless-enabled cooking vessel (e.g., a first unit of the apparatus 100 described above). Simultaneously, a second instance of Block S110 can receive a selection for a sauce, a second instance of Block S112 can retrieve a recipe for the sauce, and second instances of Blocks S120, S122, S124, S130, S132, S134, etc. can cooperate to guide the user in cooking the sauce in a second wireless-enabled cooking vessel (e.g., a second unit of the apparatus 100 described above). In this example, the method can select a start time for the two recipes such that the stir fry dish and the sauce are done at approximately the same time, such as based on the target total cooking times for the two recipes. In this example, the method can further adjust a cooking time and/or a cooking temperature for the stir fry dish based on a change in the cooking time of the sauce (e.g., responsive to an extended over-temperature event and/or under-temperature event) such that the stir fry dish and sauce are done cooking at approximately the same time.

In this variation, multiple instances of Block S116 can execute within the cooking session to pair the computing device with multiple cooking vessels. Block S116 can further assign a color code to each selected recipe, apply a corresponding color filter to visual prompts and instructions rendered within the user interface, and/or assign a corresponding color to each cooking vessel paired to the computing device. As in the foregoing example, Block S116 can select the color blue for the stir fry dish and the color red for the sauce, apply a blue filter to all visual prompts and instructions related to the stir fry dish and shown in the user interface, apply a red filter to all visual prompts and instructions related to the sauce and shown in the user interface, transmit a command to a first cooking vessel assigned to the stir fry dish to output blue light from a visual indicator integrated into the first cooking vessel, and transmit a command to a second cooking vessel assigned to the sauce to output red light from a visual indicator integrated into the second cooking vessel, as described above. Substantially concurrent instances of Block S116 can thus assign and set indicator outputs of various cooking vessels used simultaneously by the user to cook multiple distinct dishes and/or to cook various distinct components of a single dish.

### 2.12 Variations

Various Blocks of the method can alternatively execute locally on the cooking vessel or remotely, such as on an application server hosting the native cooking guide application

The systems and methods of the embodiments can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, or any suitable combination thereof. Other systems and methods of the embodiments can be embodied and/or implemented at least in part as a machine configured to receive a computer-readable medium storing computer-readable instructions. The instructions can be executed by computer-executable components integrated by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor, though any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

I claim:

1. An apparatus for cooking over a burner, comprising:
a vessel comprising a base defining a channel extending along an external surface of the vessel and over a center of the base, the channel comprising an undercut;
a handle extending outwardly from the vessel;
a temperature sensor arranged within the channel proximal the center of the base of the vessel;
a closing panel arranged within the channel, constrained by the undercut, and cooperating with the base of the vessel to encapsulate the temperature sensor;
an electrical conductor interposed between the base of the vessel and the closing panel, the electrical conductor extending from the temperature sensor to the handle; and
a wireless communication module arranged within the handle, coupled to the electrical conductor, and transmitting a unique identifier and a value corresponding to an output of the temperature sensor to an external computing device.

2. The apparatus of claim 1, further comprising a battery arranged within the handle and supplying power to the wireless communication module, the wireless communication module further transmitting a second value corresponding to a voltage of the battery to the external computing device.

3. The apparatus of claim 1, wherein the wireless communication module is operable between a first mode and a second mode, the wireless communication module broadcasting the unique identifier at a first rate in the first mode, transitioning from the first mode into the second mode in response to wireless communication with the external computing device, and broadcasting the unique identifier and a value corresponding to a substantially current output of the temperature sensor at a second rate in the second mode.

4. The apparatus of claim 3, wherein the wireless communication module broadcasts the unique identifier comprising to a unique serial number assigned to the apparatus.

5. The apparatus of claim 1, wherein the vessel comprises a thermally-conductive material, and wherein the closing panel comprises a thermally-insulating material.

6. The apparatus of claim 1, further comprising a volume of uncured thermally-insulating polymer interposed between the temperature sensor and the closing panel.

7. The apparatus of claim 1, wherein the vessel comprises a frustoconical container, the channel extending along an external surface of the frustoconical container and over a central axis of the frustoconical container, and wherein the temperature sensor is coincident the central axis of the frustoconical container.

8. The apparatus of claim 1, wherein the channel comprises a linear T-slot defining the undercut, and wherein the closing panel comprises an elongated member defining a T-section arranged within the channel and captured by the T-slot.

9. The apparatus of claim 8, wherein the closing panel is oversized for the channel and engages the channel by an interference fit.

10. The apparatus of claim 9, wherein the closing panel is fastened to the vessel by a machine screw.

11. The apparatus of claim 8, wherein the closing panel is welded to the base of the vessel along an edge of the channel.

12. The apparatus of claim 1, further comprising a processor arranged within the handle, coupled to the temperature sensor, and transforming an analog output of the temperature sensor into a digital value, wherein the wireless communication module transmits the digital value to the external computing device.

13. The apparatus of claim 1, further comprising an accelerometer arranged within the handle, and wherein the wireless communication module further transmits a second value corresponding to a substantially current output of the accelerometer to the external computing device.

14. The apparatus of claim 1, wherein the handle displays a length rule comprising hashes and length markings.

15. The apparatus of claim 1, further comprising a multi-color light source arranged within the handle, wherein the wireless communication module receives a color selection from the external computing device, and wherein the multi-color light source selectively outputs colored light according to the color selection received from the external computing device.

16. The apparatus of claim 1, further comprising a second temperature sensor arranged vertically over the temperature sensor, the temperature sensor interposed between the second temperature sensor and the closing panel, and wherein the wireless communication module transmits a second value corresponding to an output of the second temperature sensor, the second value paired with the value corresponding to the output of the temperature sensor for a particular sample in time.

17. The apparatus of claim 1, wherein the vessel comprises a keel extending from the base to the handle, the keel defining an internal bore, wherein the electrical conductor passes from the channel through the internal bore and into the handle, wherein the channel is coincident the internal bore, and wherein the closing panel terminates over the keel.

18. An apparatus for cooking over a burner, comprising:
a vessel comprising a base defining a channel extending along an external surface of the vessel and over a central axis of the base, the channel comprising an undercut;
a handle extending outwardly from the vessel;
a temperature sensor arranged within the channel and coincident the central axis of the base of the vessel;
a closing panel arranged within the channel, constrained by the undercut, and cooperating with the base of the vessel to encapsulate the temperature sensor;
an electrical conductor interposed between the base of the vessel and the closing panel, the electrical conductor extending from the temperature sensor to the handle;
a thermal isolator interposed between the temperature sensor and the closing panel;
a battery arranged within the handle; and
a wireless communication module arranged within the handle, powered by the battery, and operable between a first mode and a second mode, the wireless communication module broadcasting a unique identifier at a first rate in the first mode, transitioning from the first mode into the second mode in response to wireless communication with an external computing device, and transmitting a first value corresponding to a substantially current output of the temperature sensor and a second value corresponding to a voltage of the battery at a second rate to the external computing device in the second mode.

19. The apparatus of claim 18, wherein the channel comprises a linear T-slot defining the undercut, and wherein the closing panel comprises an elongated member defining a T-section arranged within the channel and captured by the T-slot.

20. The apparatus of claim 18, wherein the electrical conductor comprises a lead welded to one end of the temperature sensor, wherein the lead is encased in a woven fiberglass sleeve.

21. The apparatus of claim 18, wherein the channel defines a long axis substantially parallel to a length of the handle.
